(19) United States
(12) Patent Application Publication
(10) Pub. No.: US 2026/0149797 A1
(43) Pub. Date: May 28, 2026

(54) SPATIAL IMAGE PROCESSING WITH ADJUSTABLE RECTIFICATION OF STEREOSCOPIC IMAGE PAIRS

(71) Applicant: QUALCOMM Incorporated, San Diego, CA (US)

(72) Inventors: Narayana Karthik RAVIRALA, San Diego, CA (US); Dharanya VANCHINATHAN, San Diego, CA (US); Shizhong LIU, San Diego, CA (US); Weiliang LIU, San Diego, CA (US)

(21) Appl. No.: 19/179,744

(22) Filed: Apr. 15, 2025

Related U.S. Application Data
(60) Provisional application No. 63/722,506, filed on Nov. 19, 2024.

(51) Int. Cl. H04N 13/139; H04N 13/128; H04N 13/246; H04N 13/25

(52) U.S. Cl. CPC H04N 13/139; H04N 13/128; H04N 13/246; H04N 13/25

(57) ABSTRACT

Systems and techniques are provided for processing image data. A process can include obtaining a pair of images with a first zoom level and including first and second image data of a scene obtained using a first and second camera, respectively. Information indicative of a second zoom level different from the first zoom level can be obtained, and a rectification matrix corresponding to the second camera can be determined based on a scale factor corresponding to the second zoom level. Zoomed second image data can be generated based on using the rectification matrix to warp a portion of the second image data determined based on the second zoom level. A zoomed pair of images associated with the second zoom level can be outputted to include the zoomed second image data and zoomed first image data comprising a portion of the first image data corresponding to the second zoom level.

### CROSS-REFERENCE TO RELATED APPLICATIONS

This application claims the benefit of U.S. Provisional Application No. 63/722,506, filed Nov. 19, 2024, which is hereby incorporated by reference, in its entirety and for all purposes.

### FIELD

The present disclosure generally relates to image processing. For example, aspects of the present disclosure are related to systems and techniques for performing image processing associated with stereoscopic images and/or spatial video corresponding to a plurality of frames of stereoscopic image pairs.

### BACKGROUND

Many devices and systems allow a scene to be captured by generating images (also referred to as frames or image frames) and/or video data (including multiple frames) of the scene. For example, a camera or a device including a camera can capture one or more images of a scene (e.g., a still image of the scene, one or more frames of a video of the scene, etc.). In some cases, the one or more images can be processed for performing one or more functions, can be output for display, can be output for processing and/or consumption by other devices, among other uses.

Disparity estimation is a type of depth estimation that can be performed based on two (or more) images that depict the same scene from slightly different viewpoints. For example, disparity estimation can be performed for pairs of stereoscopic images (e.g., also referred to as stereo images or stereo image pairs), such as a left-right stereo image pair, an upper-lower stereo image pair, etc. Stereo image pairs can be obtained using a stereo camera (e.g., a single camera device that includes two imaging sensors or sub-systems located in different positions). In some examples, stereo image pairs can be obtained using multiple different camera devices (e.g., a first camera device is used to capture a first image of the stereo pair, and a separate, second camera device is used to capture the second image of the stereo pair). In some examples, stereo image pairs can be obtained using a single camera device, where the first and second images of the stereo pair are captured at different moments in time and using different viewpoints of the scene.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for image processing. According to at least one illustrative example, a method of processing image data is provided. The method includes: obtaining a pair of images corresponding to a scene, wherein the pair of images includes first image data of the scene obtained using a first camera and second image data of the scene obtained using a second camera, and wherein the pair of images is associated with a first zoom level; obtaining information indicative of a second zoom level wherein the second zoom level is different from the first zoom level; determining, based on the second zoom level, a rectification matrix corresponding to the second camera; generating zoomed second image data based on warping a portion of the second image data using the rectification matrix, wherein the portion of the second image data is determined based on the second zoom level; and outputting a zoomed pair of images corresponding to the scene and associated with the second zoom level, wherein the zoomed pair of images includes the zoomed second image data and zoomed first image data comprising a portion of the first image data corresponding to the second zoom level.

In another illustrative example, an apparatus for processing image data is provided. The apparatus includes at least one memory and at least one processor coupled to the at least one memory and configured to: obtain a pair of images corresponding to a scene, wherein the pair of images includes first image data of the scene obtained using a first camera and second image data of the scene obtained using a second camera, and wherein the pair of images is associated with a first zoom level; obtain information indicative of a second zoom level, wherein the second zoom level is different from the first zoom level; determine, based on the second zoom level, a rectification matrix corresponding to the second camera; generate zoomed second image data based on warping a portion of the second image data using the rectification matrix, wherein the portion of the second image data is determined based on the second zoom level; and output a zoomed pair of images corresponding to the scene and associated with the second zoom level, wherein the zoomed pair of images includes the zoomed second image data and zoomed first image data comprising a portion of the first image data corresponding to the second zoom level.

In another illustrative example, a non-transitory computer-readable storage medium comprising instructions stored thereon which, when executed by at least one processor, causes the at least one processor to: obtain a pair of images corresponding to a scene, wherein the pair of images includes first image data of the scene obtained using a first camera and second image data of the scene obtained using a second camera, and wherein the pair of images is associated with a first zoom level; obtain information indicative of a second zoom level, wherein the second zoom level is different from the first zoom level; determine, based on the second zoom level, a rectification matrix corresponding to the second camera; generate zoomed second image data based on warping a portion of the second image data using the rectification matrix, wherein the portion of the second image data is determined based on the second zoom level; and output a zoomed pair of images corresponding to the scene and associated with the second zoom level, wherein the zoomed pair of images includes the zoomed second image data and zoomed first image data comprising a portion of the first image data corresponding to the second zoom level.

In another illustrative example, an apparatus is provided for processing image data. The apparatus includes: means for obtaining a pair of images corresponding to a scene, wherein the pair of images includes first image data of the scene obtained using a first camera and second image data of the scene obtained using a second camera, and wherein the pair of images is associated with a first zoom level; means for obtaining information indicative of a second zoom level wherein the second zoom level is different from the first zoom level; means for determining, based on the second zoom level, a rectification matrix corresponding to the second camera; means for generating zoomed second image data based on warping a portion of the second image data using the rectification matrix, wherein the portion of the second image data is determined based on the second zoom level; and means for outputting a zoomed pair of images corresponding to the scene and associated with the second zoom level, wherein the zoomed pair of images includes the zoomed second image data and zoomed first image data comprising a portion of the first image data corresponding to the second zoom level.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof so that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1A is a block diagram illustrating an example architecture of an image capture and processing system, in accordance with some examples;

FIG. 1B illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 3 is a block diagram illustrating an example of a split-architecture extended reality (XR) XR system including an XR head-mounted display (HMD) and a companion device, in accordance with some examples;

FIG. 4 is a diagram illustrating an example of a stereo image pair comprising a left image frame obtained using a first camera and a right image frame obtained using a second camera, in accordance with some examples;

FIG. 5 is a diagram illustrating an example of an image processing engine configured to generate a rectified stereo image pair corresponding to a first and second image obtained using a first and second camera, in accordance with some examples;

FIG. 6 is a diagram illustrating an example of an image processing engine configured to generate rectified stereo image pairs using adjustable rectification to implement one or more of an adjustable zoom, an adjustable parallax, and/or object manipulation, in accordance with some examples;

FIG. 7A is a diagram illustrating the roll, pitch, and yaw axes of a camera, in accordance with some examples;

FIG. 7B is a diagram illustrating an example of backward warping to obtain a final rectified image using a first image included in a stereo image pair and a rectification matrix corresponding to a second input image included in the stereo image pair and configured as a reference image, in accordance with some examples;

FIG. 8 is a diagram illustrating a process for real-time calibration (RTC) associated with estimation of one or more rotation matrices and/or rectification matrices, in accordance with some examples;

FIG. 9 is a diagram illustrating an example of object manipulation to remove and/or reposition one or more objects within a three-dimensional (3D) scene corresponding to a plurality of stereo image pairs configured as a plurality of frames of spatial video, in accordance with some examples;

FIG. 10 is a diagram illustrating another example of object manipulation to remove and/or reposition one or more objects within a 3D scene corresponding to a plurality of stereo image pairs configured as a plurality of frames of spatial video, in accordance with some examples;

FIG. 11 is a flow diagram illustrating an example of a process for processing image and/or video data, in accordance with some examples; and

FIG. 12 is a block diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects of the application. However, it will be apparent that various aspects and examples may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras, as an example of image capture devices, can be provided in various forms and form factors, including dedicated or standalone cameras and other imaging systems, as well as smartphones, mobile computing devices, user computing devices, etc., where camera functionalities are combined with one or more additional functionalities in the same device. In some examples, mobile cameras or mobile camera devices can refer to image capture devices such as smartphones, mobile computing devices, user computing devices, etc. Some mobile camera devices may include multiple imaging sensors (e.g., multiple cameras), lenses, focal lengths, imaging systems, etc.

Mobile camera devices can include one or more displays for outputting (e.g., displaying) to a user of the mobile camera device one or more image preview frames of a scene or composition prior to performing image capture (e.g., obtaining a captured image frame using the mobile camera device). For example, the one or more image preview frames can be provided as a live preview that updates as the user changes the position and/or orientation of the mobile camera device, or as the user changes one or more imaging parameters or camera settings of the mobile camera device, etc. The image preview frames can correspond to the imaged scene and/or composition that would be captured by the mobile camera device in response to receiving a user input to capture a frame. For example, the user input to capture a frame can correspond to a user input or user selection of a camera shutter or camera trigger, etc. The one or more image preview frames can be output by the mobile camera device prior to and/or without the mobile camera device receiving the user input to capture a frame. A captured image frame can be obtained by the mobile camera device in response to receiving the user input to the capture the frame.

As used herein, an “image frame” can refer to a frame of image data captured corresponding to a still photograph, and/or can refer to a frame of image data that captured as one frame of video included in a plurality of frames of video. For example, an “image frame” can be a standalone still photograph and/or can be a video frame that is included in a plurality of video frames corresponding to a video capture. An image preview frame can be a preview of the captured image frame that would be obtained using the current camera settings and current camera position and orientation. In some aspects, an image preview frame can be an preview frame corresponding to a photograph and/or can be a preview frame corresponding to a video (e.g., a video preview frame included in a plurality of video preview frames, such as a time-ordered sequence of video preview frames). In some cases, the image preview frame can be a lower-quality or reduced-quality image relative to a captured image frame. For example, image preview frames can be obtained with lower relative image quality to provide a real-time update or refresh rate to the image preview output displayed in a viewfinder or user interface of the mobile camera device. Image preview frames may also be obtained with lower relative image quality to reduce the power consumption of the mobile camera device (e.g., based on the higher relative image quality associated with captured imaged frames corresponding to a higher power consumption by the mobile camera device).

As used herein, a preview of an image can also be referred to as a “preview frame” and/or a “captured image preview frame.” In some aspects, a captured image may correspond to a preview frame that was generated earlier in time or concurrently with generating (e.g., capturing) the captured image frame. In one example, a first preview frame can be captured and/or outputted prior to receiving an input to capture a frame. The input to capture a frame can be received subsequent to capturing and/or outputting the first preview frame. A captured frame can be captured and/or outputted based on the input to capture a frame, where the captured frame is subsequent to the first preview frame and the input to capture a frame. In some cases, the first preview frame is a real-time image preview frame corresponding to an image composition of a scene, and the captured frame is a captured image frame corresponding to the same image composition of the scene and/or corresponding to the real-time image preview frame.

One or more image frames obtained using one or more cameras can be used to perform depth estimation. Depth estimation can correspond to determining an estimated distance (e.g., depth) from the one or more cameras (or imaging sensors thereof) to respective objects represented or depicted within the one or more images frames. Depth estimation based on a single input image can be referred to as monocular depth estimation. Depth estimation based on a pair of stereoscopic images (e.g., corresponding to two slightly different views of the same scene) can be referred to as stereo depth estimation and/or depth-from-stereo (DFS).

Depth estimation can be used for many applications (e.g., XR applications, vehicle applications, etc.). In some cases, depth estimation can be used to perform occlusion rendering, for example based on using depth and/or object segmentation information to render virtual objects in a 3D environment. In some cases, depth estimation can be used to perform 3D reconstruction, for example based on using depth information and one or more poses to create a mesh of a scene. In some cases, depth estimation can be used to perform collision avoidance, for example based on using depth information to estimate distance(s) to one or more objects.

Depth estimation can be used to generate three-dimensional content (e.g., such as XR content) with greater accuracy. For example, depth estimation can be used to generate XR content that combines a baseline image or video with one or more augmented overlays of rendered 3D objects. The baseline image data (e.g., an image or a frame of video) that is augmented or overlaid by an XR system may be a two-dimensional (2D) representation of a 3D scene. Depth information can be obtained from one or more depth sensors which can include, but are not limited to, Time of Flight (ToF) sensors and Light Detection and Ranging (LIDAR) sensors. Depth information can additionally, or alternatively, be obtained as a prediction or estimation that is generated based on one or more image inputs, depth inputs, etc. Accurate depth information can be used for autonomous and/or self-driving vehicles to perceive a driving scene and surrounding environment, and to estimate the distances between the autonomous vehicle and surrounding environmental objects (e.g., other vehicles, pedestrians, roadway elements, etc.). Accurate depth information is needed for the autonomous vehicle to determine and perform appropriate control actions, such as velocity control, steering control, braking control, etc.

Depth information can be used for extended reality (XR) applications for functions such as indoor scene reconstruction and obstacle detection for users, among various others. Accurate depth information can be needed for improved integration of real scenes with virtual scenes and/or to allow users to smoothly and safely interact with both their real-world surroundings and the XR or VR environment. Depth information can be used in robotics to perform functions such as navigation, localization, and interaction with physical objects in the robot's surrounding environment, among various other functions. Accurate depth information can be needed to provide improved navigation, localization, and interaction between robots and their surrounding environment (e.g., to avoid colliding with obstacles, nearby humans, etc.). In some examples, depth information can be used for image enhancement and/or other image manipulation applications or functions. For example, depth information can be used to differentiate foreground and background portions of an image, which can subsequently be processed, manipulated, enhanced, etc., separately. In some examples, depth information can be used to generate a bokeh effect that simulates an image taken with a low aperture value (e.g., a large physical aperture size), where the foreground of the image is sharply in focus while the background of the image is blurred (e.g., out of focus).

As used herein, a stereo image pair can include a first image (e.g., corresponding to a first view of a scene) and a second image (e.g., corresponding to a second view of the scene, the second view different from the first view). The first and second images of a stereo image pair are also referred to herein as the “left” image and the “right” image, respectively. The left image of a stereo image pair can be associated with a “left camera,” which may refer to an image sensor or other imaging system used to obtain the left image. The right image of a stereo image pair can be associated with a “right camera,” which may refer to an image sensor or other imaging system used to obtain the right image. As used herein, the terms “left camera” and “right camera” may refer to separate camera devices and/or may refer to a stereo camera device (or other single camera device that includes two image sensors or imaging sub-systems).

Disparity estimation can be performed to determine or otherwise estimate disparity information corresponding to a stereo image pair. Given a point or location of a scene that is depicted in both images of a stereo image pair, the disparity can be determined as the difference between the corresponding pixel location in the left and right images of the stereo pair. In one illustrative example, disparity can be the difference in image location (e.g., pixel location) of the same 3D point when projected under perspective to the left and right cameras associated with capturing a stereo image pair. For example, any point in the scene that is visible in both cameras will be projected to a pair of image points in the two images (e.g., referred to as a conjugate pair). The displacement between the pixel positions of the two points is the disparity. Disparity estimation can be used to generate a disparity map corresponding to a stereo image pair. The disparity map can have the same pixel resolution as the stereo image pair, and can include a calculated disparity value for each pixel location of the plurality of pixels included in the resolution. The disparity map can be indicative of the disparity between an anchor image (e.g., either the left or right image of the stereo pair, selected and used as a baseline for generating the disparity map) and a non-anchor image (e.g., the remaining one of either the left or right image of the stereo pair). The magnitude or absolute value of the disparity may be the same in the disparity map generated using the left image of a stereo pair as the anchor (e.g., a left-to-right disparity map) as it is in the disparity map generated using the right image of the stereo pair as the anchor (e.g., a right-to-left disparity map). The directionality or sign of the disparities in the left-to-right disparity map may be the opposite of those in the right-to-left disparity map.

A disparity map generated for a stereo image pair can be used to generate depth information of the scene depicted in the stereo image pair. For example, depth information (e.g., a depth estimate) can be determined using the disparity map and camera intrinsic information corresponding to the left and right cameras used to capture the left and right images (respectively), of the stereo image pair. Camera intrinsic information can include the distance between the image sensor or imaging plane of the left camera and the image sensor or imaging plane of the right camera (e.g., the baseline distance between the left and right cameras). The camera intrinsic information can additionally include a focal length associated with the left camera/left image and a focal length associated with the right camera/right image. Given the baseline distance and respective focal lengths of the left and right cameras, a one-to-one mapping between disparity information and depth information can be calculated. For example, a depth map can be generated based on calculating, for each pixel location of the disparity map, a corresponding depth value given by: depth=(baseline*focal length)/disparity.

In some examples, various feature matching algorithms can be used to estimate the disparity between a pair of stereo images (e.g., feature matching algorithms can be used to generate or estimate a disparity map corresponding to a stereo image pair). Feature matching algorithms may implement local or global feature matching. For example, local feature matching can be implemented to naively look for matches across local patches based on a robust function. Global feature matching can be implemented using relatively more complex optimization techniques, and may also be referred to as optimization-based feature matching algorithms.

Systems, apparatuses, processes (also referred to as methods), and computer-readable media (collectively referred to as “systems and techniques”) are described herein that can be used to provide spatial image capture and/or spatial image processing with adjustable rectification of stereoscopic image pairs obtained using a respective first and second camera of an image capture device. In some examples, the stereoscopic image pairs (e.g., also referred to as “stereo image pairs” or “stereo pairs”) can be obtained using respective first and second cameras of the same image capture device, where the first and second cameras are associated with first and second focal lengths, respectively, that are different from one another. In some cases, the systems and techniques can be used to perform image processing with adjustable rectification for an input comprising a plurality of stereo image pairs (e.g., a stream of stereo image pairs, etc.). The plurality of stereo image pairs may comprise a plurality of frames corresponding to or associated with a spatial video. For example, the plurality of stereo image pairs can be processed according to the systems and techniques described herein to perform adjustable rectification corresponding to one or more of a zoom adjustment, a parallax adjustment, and/or manipulation of one or more objects within the stereo image pairs comprising the spatial video frames.

In some examples, the stereo image pairs can be output for display as a spatial video on a head-mounted display (HMD) device and/or an XR device such as a virtual reality (VR) device, an augmented reality (AR) device, or a mixed reality (MR) device, or other device), etc. In some cases, the stereo image pairs can be obtained by respective first and second cameras included in a companion device of the HMD, where the companion device is configured to perform image processing corresponding to the adjustable rectification for zoom adjustment, parallax adjustment, and/or object manipulation. In some examples, the image processing can be implemented using split perception processing distributed across the companion device and the HMD. For example, the companion device can obtain the stereo image pairs and perform a first portion of the image processing corresponding to the adjustable rectification, and the HMD can perform a remaining second portion of the image processing corresponding to the adjustable rectification, etc. In some examples, the companion device can obtain the stereo image pairs and may transmit the captured images and associated information to the HMD, where the HMD is configured to perform the image processing corresponding to the adjustable rectification based on receiving the captured images of the stereo image pairs from the companion device.

In some examples, the image processing corresponding to the adjustable rectification can be used to determine one or more adjustments to a rectification matrix corresponding to a stereo image pair obtained using the first and second cameras of the image capture device (e.g., a companion device associated with the HMD, etc.). For example, rectification can be performed using a rectification matrix configured to minimize the vertical disparity between an image pair corresponding to a scene. In some examples, rectification can be performed using a rectification matrix configured to warp and align the left and right images of a stereo image pair (e.g., or any image pair depicting a same scene) to have zero vertical disparity. The rectification matrix can be applied to transform one (or both) of the images of a stereo image pair to appear as if the images were captured by perfectly aligned cameras with only horizontal displacement therebetween (e.g., a vertical disparity of zero). A vertical disparity of zero can be obtained by calculating and applying the rectification matrix to align corresponding points in the left and right images of the stereo pair to be on the same horizontal scanline, based on the rectification matric correcting for any vertical misalignment between the cameras, correcting for any rotational differences between the cameras, etc. After rectification, the two images of the stereo image pair (e.g., left and right images) can form a rectified stereo image pair where corresponding points in the left and right images have the same vertical coordinate along the vertical axis (e.g., y-axis), and disparity (e.g., displacement) is present only along the horizontal axis (e.g., x-axis). In some examples, rectification can be performed to obtain a rectified stereo image pair with epipolar lines within the respective left and right images of the stereo pair aligned horizontally.

In some examples, the systems and techniques can be configured to perform image processing corresponding to an adjustable rectification between images of stereo image pair, where the adjustable rectification implements a zoom adjustment of the rectified stereo image pair. For example, zooming in or out can correspond to changing the focal length of a camera. Zooming in or out for a stereo image pair captured by first and second cameras (e.g., a stereo camera pair) can correspond to changing the focal lengths of both cameras of the stereo camera pair. In one illustrative example, the systems and techniques can determine a respective focal length change or an updated focal length for the first camera and the second camera used to capture a stereo image pair. The determined respective focal length changes can be used for implementing a configured zoom in or zoom out for an already captured stereo image pair. For example, the updated focal length information for the first and/or second camera(s) of the stereo pair can be provided to a real-time calibration (RTC) engine that may be used to dynamically obtain rectified stereo image pairs. The RTC engine can be configured to analyze information depicted within the stereo image pair, for example information corresponding to a scene and/or one or more objects within the stereo image pair. The RTC engine can determine calibration and/or rectification information that may dynamically adapt to changes in imaging parameters corresponding to movements or changes in the imaging hardware used by the stereo camera pair to obtain the images. For example, the RTC engine can determine dynamic calibration and/or rectification information that adapts to changes in lens position corresponding to an optical image stabilization (OIS) or electronic image stabilization (EIS) module of the camera(s), etc.

In some examples, the systems and techniques can be configured to perform image processing corresponding to an adjustable rectification between images of a stereo image pair, where the adjustable rectification implements a parallax adjustment of the rectified stereo image pair. For example, the parallax adjustment can correspond to determining an updated rectification matrix for an increased parallax between the first and second cameras used to obtain the stereo image pair, or can correspond to determining an updated rectification matrix for a decreased parallax between the first and second cameras. Adjusting the rectification applied to the stereo image pair to increase or decrease the parallax between the stereo camera pair can be used to adjust the perceived depth of objects in the scene (e.g., perceived depth to a viewer of the adjusted rectified stereo image pair on an HMD or other device for playback of a spatial video comprising a plurality of frames of adjusted rectified stereo image pairs, etc.). In some examples, the depth of the scene can be adjusted or manipulated based on determining an updated rectification matrix corresponding to a change in yaw between the first and second cameras of the stereo pair. The yaw change can be implemented after an initial rectification is performed to determine an initial rectification matrix for aligning the stereo image pair vertically to have zero vertical disparity. For example, increasing the diverging angle between the first and second cameras (e.g., rotating or yawing the cameras away from a parallel configuration where the optical axes of the two cameras are parallel) corresponds to increasing the horizontal disparity between the respective locations of an object in the left image and the same object in the right image of the stereo pair. Increasing the camera divergence and therefore horizontal disparity can correspond to increasing or enhancing the depth perception for a user viewing a spatial video including the adjusted rectified stereo image pair.

Various aspects of the present disclosure will be described with respect to the figures.

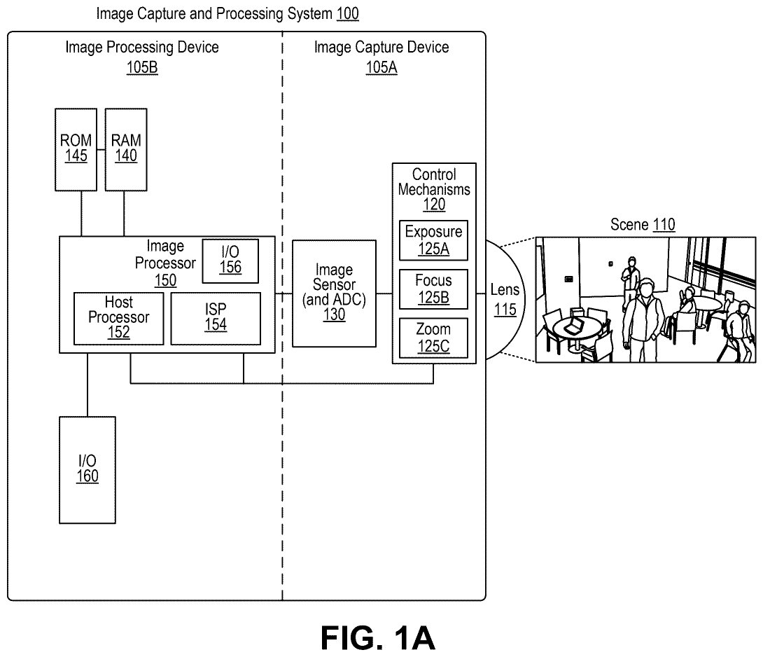

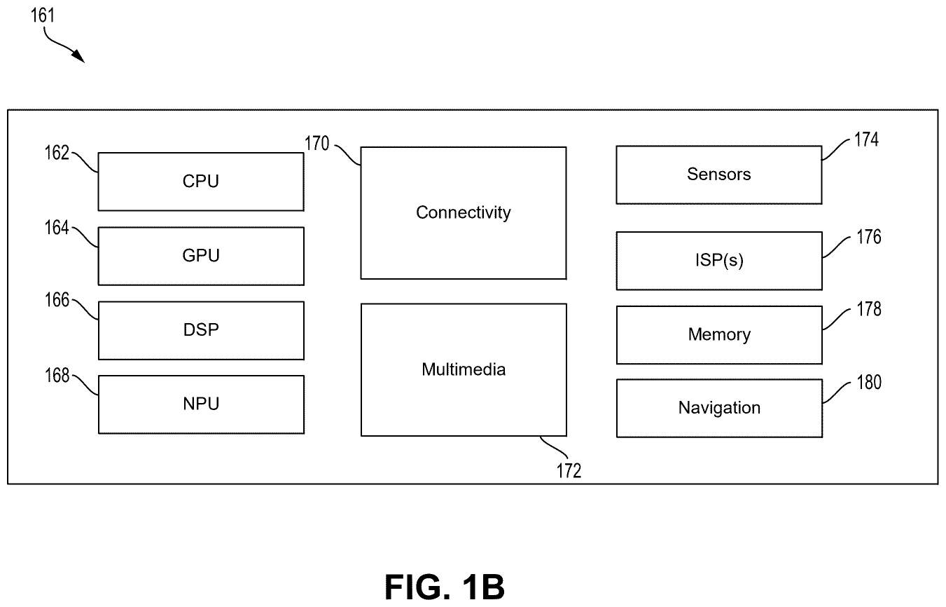

FIG. 1A is a block diagram illustrating an architecture of an image capture and processing system 100 (which can also be referred to as an imaging system). The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for example, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B can store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For example, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output by the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

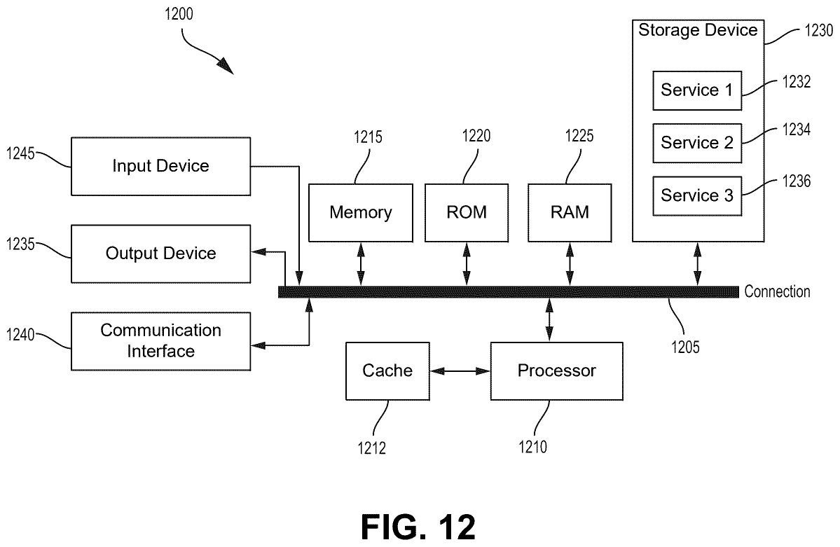

The image processor 150 may include one or more processors, such as one or more image signal processors (ISPs) (including ISP 154), one or more host processors (including host processor 152), and/or one or more of any other type of processor 1210 discussed with respect to the computing device architecture 1200 of FIG. 12. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 (e.g., 1225 of FIG. 12), read-only memory (ROM) 145 (e.g., 1220 of FIG. 12), a cache (e.g., 1212 of FIG. 12), a memory unit (e.g., system memory 1215 of FIG. 12), another storage device (e.g., 1230 of FIG. 12), or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1235 of FIG. 12, any other input devices 1245 of FIG. 12, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the processing system 100 and one or more peripheral devices, over which the processing system 100 may receive data from the one or more peripheral device and/or transmit data to the one or more peripheral devices. The I/O 160 may include one or more wireless transceivers that enable a wireless connection between the processing system 100 and one or more peripheral devices, over which the processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1A, a vertical dashed line divides the image capture and processing system 100 of FIG. 1A into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For example, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1A. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens (or sensor) noise correction, de-mosaicing, color conversion, correction or enhancement/suppression of image attributes, denoising filters, sharpening filters, among others. Each module of the ISP 154 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

FIG. 1B illustrates an example implementation of a system-on-a-chip (SOC) 161, which may include a central processing unit (CPU) 162 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 168, in a memory block associated with a CPU 162, in a memory block associated with a graphics processing unit (GPU) 164, in a memory block associated with a digital signal processor (DSP) 166, in a memory block 178, and/or may be distributed across multiple blocks. Instructions executed at the CPU 162 may be loaded from a program memory associated with the CPU 162 or may be loaded from a memory block 178.

The SOC 161 may also include additional processing blocks tailored to specific functions, such as a GPU 164, a DSP 166, a connectivity block 170, which may include fifth generation (5G) connectivity, fourth generation long term evolution (4G LTE) connectivity, Wi-Fi connectivity, USB connectivity, Bluetooth connectivity, and the like, and a multimedia processor 172 that may, for example, detect and recognize gestures. In one implementation, the NPU is implemented in the CPU 162, DSP 166, and/or GPU 164. The SOC 161 may also include a sensor processor 174, image signal processors (ISPs) 176, and/or navigation module 180, which may include a global positioning system.

The SOC 161 may be based on an ARM instruction set. In an aspect of the present disclosure, the instructions loaded into the CPU 162 may comprise code to search for a stored multiplication result in a lookup table (LUT) corresponding to a multiplication product of an input value and a filter weight. The instructions loaded into the CPU 162 may also comprise code to disable a multiplier during a multiplication operation of the multiplication product when a lookup table hit of the multiplication product is detected. In addition, the instructions loaded into the CPU 162 may comprise code to store a computed multiplication product of the input value and the filter weight when a lookup table miss of the multiplication product is detected.

SOC 161 and/or components thereof may be configured to perform image processing using machine learning techniques according to aspects of the present disclosure discussed herein. For example, SOC 161 and/or components thereof may be configured to perform semantic image segmentation according to aspects of the present disclosure. In some cases, by using neural network architectures such as transformers and/or shifted window transformers in determining one or more segmentation masks, aspects of the present disclosure can increase the accuracy and efficiency of semantic image segmentation.

In general, machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For example, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For example, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

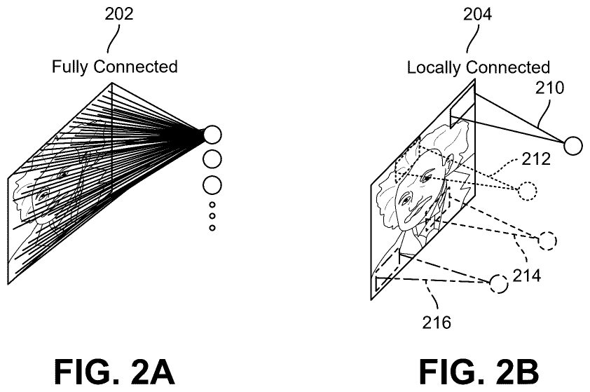

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

As noted above, the systems and techniques described herein can be used to provide spatial image capture and/or spatial image processing with adjustable rectification of stereoscopic image pairs obtained using a respective first and second camera of an image capture device. In some examples, the stereo image pairs can be output for display as a spatial video on a head-mounted display (HMD) device and/or an XR device such as a virtual reality (VR) device, an augmented reality (AR) device, or a mixed reality (MR) device, or other device), etc. In some cases, the stereo image pairs can be obtained by respective first and second cameras included in a companion device of the HMD, where the companion device is configured to perform image processing corresponding to the adjustable rectification for zoom adjustment, parallax adjustment, and/or object manipulation.

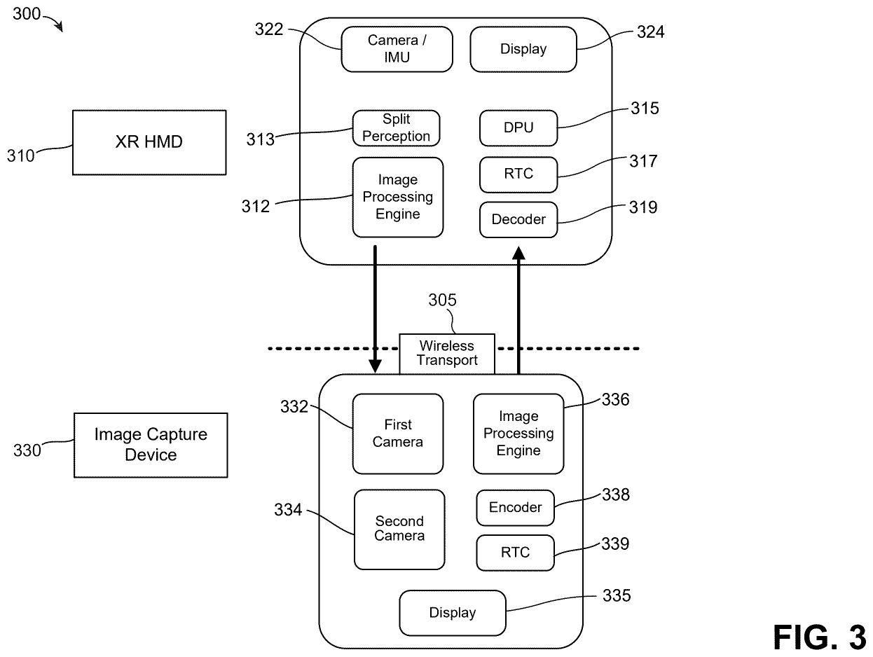

FIG. 3 is a block diagram illustrating an example of a split-architecture XR system 300 including an XR HMD 310 and an image capture device 330, in accordance with some examples. In some examples, the image capture device 330 can implement the image capture and processing system 100 of FIG. 1A. In some cases, the image capture device 330 can be the same as or similar to the image capture device 105A of FIG. 1A, and the XR HMD 310 can be the same as or similar to the image processing device 105B. For example, the split-architecture XR system 300 comprising the XR HMD 310 and the image capture device 330 can correspond to and/or can be used to implement the image processing device 105B and image capture device 105A, respectively, of the image capture and processing system 100 of FIG. 1A.

In some examples, the image capture device 330 can be an image capture device including two or more cameras that can be used to capture respective images of a stereo image pair. For example, the image capture device 330 can include at least a first camera 332 and a second camera 334, which can be used to capture a first image and a second image, respectively, included in a stereo image pair. The image capture device 330 can include a display 335, which can be used to output one or more image frames and/or preview frames corresponding to the stereo image pair captured by the first camera 332 and second camera 334. As used herein, a stereo image pair can include a first image (e.g., corresponding to a first view of a scene) and a second image (e.g., corresponding to a second view of the scene, the second view different from the first view). The first and second images of a stereo image pair are also referred to herein as the “left” image and the “right” image, respectively. The left image of a stereo image pair can be associated with a “left camera,” which may refer to an image sensor or other imaging system used to obtain the left image. The right image of a stereo image pair can be associated with a “right camera,” which may refer to an image sensor or other imaging system used to obtain the right image. As used herein, the terms “left camera” and “right camera” may refer to separate camera devices and/or may refer to a stereo camera device (or other single camera device that includes two image sensors or imaging sub-systems). In one illustrative example, the first camera 332 of the image capture device 330 can be used to capture the left image of a stereo image pair, and the second camera 334 of the image capture device 330 can be used to capture the right image of the stereo image pair, or vice versa.

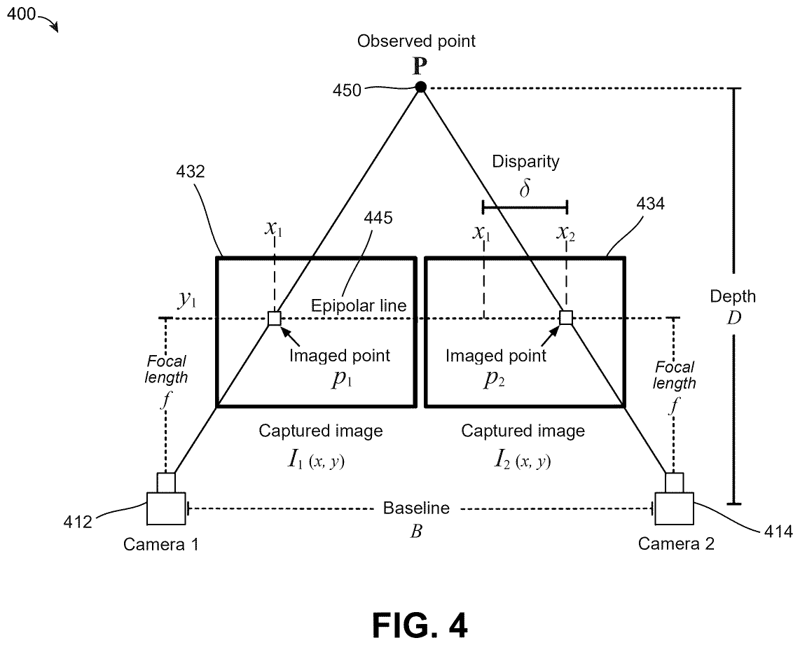

The image capture device 330 can include one or more image processing engines (IPEs) 336, which can be included in and/or can correspond to one or more image processing pipelines of the image capture device 330. In some examples, the image capture device 330 includes an encoder 338, which may be used to generate encoded image data and/or encoded video data that can be transmitted over a wireless transport channel 305. For example, encoded image or video data can be generated by the encoder 338 of the image capture device 330 and transmitted over the wireless transport channel 305 to a corresponding decoder 319 of the XR HMD 310, etc. In some cases, the encoder 338 of the image capture device 330 can be used to perform HEVC encoding, including HEVC encoding of spatial video generated using a plurality of spatial video frames comprising stereo image pairs captured using the first camera 332 and the second camera 334. In some examples, the encoder 338 can generate encoded HEVC video data which may be transmitted over the wireless transport channel 305, including to the HMD 310 and/or various other decoder devices. In some aspects, the encoded HEVC spatial video data generated using the encoder 338 of the image capture device 330 can include information indicative of a camera baseline corresponding to the first camera 332 and the second camera 334 (e.g., such as the baseline B between the first camera 412 and the second camera 414 of FIG. 4, which in some aspects may be the same as or similar to the first camera 332 and the second camera 334, respectively, of the image capture device 330 of FIG. 3).

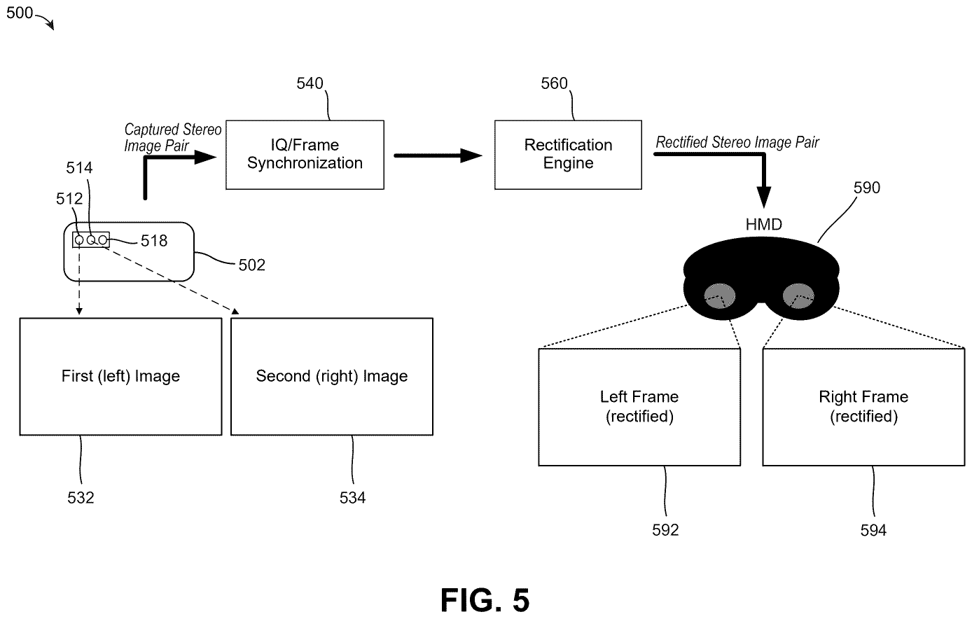

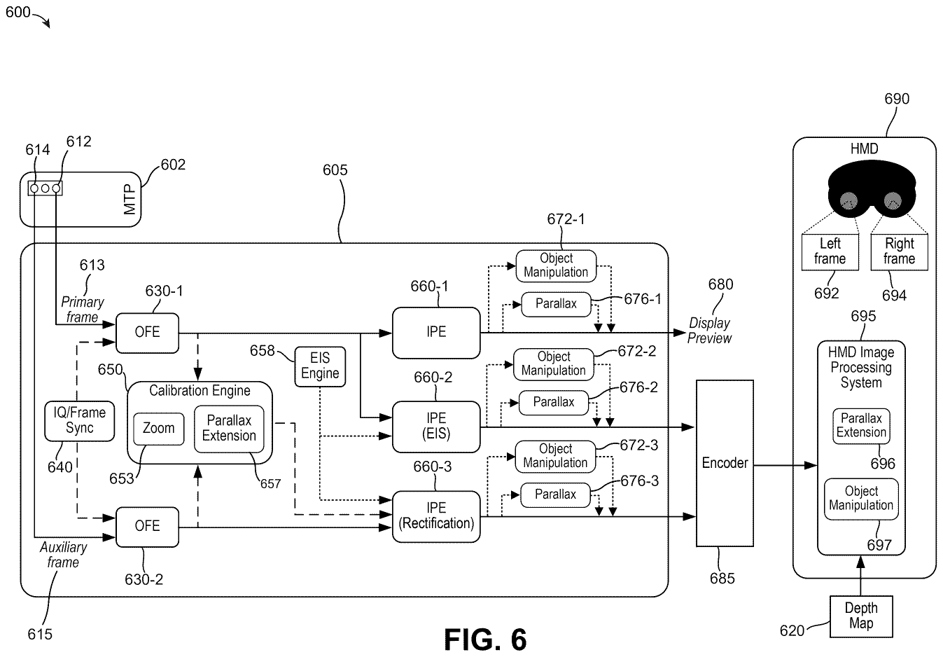

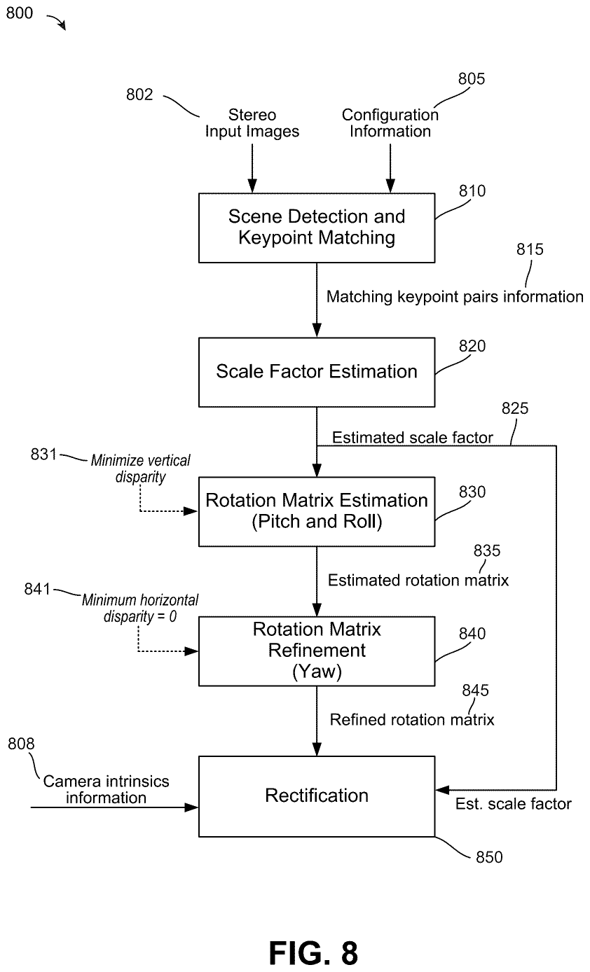

In some examples, the image capture device 330 can include a real-time calibration (RTC) engine 339, which can be used to dynamically obtain a rectified stereo image pair corresponding to a captured stereo image pair obtained using the first camera 332 and the second camera 334. The RTC engine 339 can be configured to analyze information depicted within the stereo image pair, for example information corresponding to a scene and/or one or more objects within the stereo image pair. The RTC engine 339 can determine calibration and/or rectification information that may dynamically adapt to changes in imaging parameters corresponding to movements or changes in the imaging hardware used by the stereo pair of cameras 332 and 334. For example, the RTC engine 339 can determine dynamic calibration and/or rectification information that adapts to changes in lens position corresponding to an optical image stabilization (OIS) or electronic image stabilization (EIS) module associated with one or more of the first camera 332 and/or the second camera 334. In some examples, the RTC engine 339 can be the same as or similar to (and/or included within, implemented by, etc.) one or more of the rectification engine 560 of FIG. 5, the calibration engine 650 of FIG. 6, the IPE and rectification engine 660-3 of FIG. 6, and/or a processing engine configured to implement the real-time calibration process 800 of FIG. 8, etc.

In some examples, the split architecture processing system 300 can be configured to split processing for one or more image processing tasks between the HMD 310 and the image capture device 330. In a split XR system, the processing load is divided (e.g., split) between an XR headset device and a host device. The XR headset device can be the XR HMD 310. The host device can also be referred to as a companion device, such as the image capture device 330 (e.g., a companion device associated with the HMD, a companion device of the split XR system, etc.). In some aspects, a split XR system can use the host device (e.g., a companion device such as the image capture device 330, etc.) to perform a majority of the processing tasks and/or XR workload, with the HMD configured to perform a remaining portion (e.g., a minority) of the processing tasks and/or XR workload of the split XR system. Various split XR system designs and/or architectures can be utilized, which may vary in the distribution of the XR processing workload across or between the HMD and the image capture device. In some examples, all processing workloads may be performed by the image capture, with the HMD used to display the rendered images (e.g., images rendered based on the processing performed by the image capture device) to the user.

The HMD 310 can include a decoder 319 that can correspond to the encoder 338 of the image capture device 330. For example, the decoder 319 of the HMD 310 can be used to decode one or more streams of encoded image or video data received by the HMD 310 over the wireless transport channel 305 from the encoder 338 of the image capture device 330. The HMD 310 can include a split perception engine 313 and a DPU 315. The HMD 310 can include an image processing engine 312 that can be the same as or similar to the image processing engine 336 of the image capture device 330. In some cases, the image processing engine 312 can perform some or all of the same image processing tasks and/or operations as can be performed by the image processing engine 336. In some cases, the image processing engine 312 of the HMD 310 can perform a subset of the image processing tasks and/or operations that can be performed by the image processing engine 336 of the image capture device 330. In some examples, the image processing engine 336 of the image capture device 330 can perform a subset of the image processing tasks and/or operations that can be performed by the image processing engine 312 of the HMD 310. In some examples, the HMD 310 can include a real-time calibration (RTC) engine 317 that can be the same as or similar to the RTC engine 339 of the image capture device 330.

In some examples, the HMD 310 can additionally include one or more cameras and/or inertial measurement units (EIUs) 322, and one or more displays 324 (e.g., display panels, etc.). For example, the HMD 310 may include a respective one or more displays 324 corresponding to a left eye output and a respective one or more displays 324 corresponding to a right eye output. In some aspects, the displays 324 can be associated with one or more eyebuffers (e.g., also referred to as XR eyebuffers, eye buffers, frame buffers, etc.). For example, the one or more displays 324 configured as left eye displays can be associated with at least one left eyebuffer configured to store rendered images for output to the user's left eye, the one or more displays 324 configured as right eye displays can be associated with at least one right eyebuffer configured to store rendered images for output to the user's right eye, etc. In some cases, the one or more displays configured as left eye displays can be configured to display images corresponding to capture by the first camera 332 of the image capture device 330, and the one or more displays configured as right eye displays can be configured to display images corresponding to capture by the second camera 334 of the image capture device 330, etc.

FIG. 4 is a diagram illustrating an example of a stereo image capture system 400 that can be used to obtain a stereo image pair comprising a left image frame corresponding to a first camera 412 and a right image frame corresponding to a second camera 414, in accordance with some examples. In some aspects, the stereo image capture system 400 can be included within and/or implemented by an image capture device including a plurality of cameras (e.g., a plurality of cameras including at least the first camera 412 and the second camera 414, etc.). In some examples, the stereo image capture system 400 can be included within and/or implemented by the image capture and processing system 100, the image processing device 105B, and/or the image capture device 105A of FIG. 1A. In some examples, the stereo image capture system 400 can be included within and/or implemented by the image capture device 330 of FIG. 3. For example, the first camera 412 of FIG. 4 can be the same as or similar to the first camera 332 of FIG. 3, and the second camera 414 of FIG. 4 can be the same as or similar to the second camera 334 of FIG. 3, etc.

In the example stereo image capture system 400, the pair of cameras 412, 414 are separated by a baseline distance B in the horizontal direction. The cameras 412 and 414 may be aligned in the vertical direction. Each camera 412 and 414 is associated with a corresponding focal length f and can be used to obtain a respective captured image in their corresponding image planes. For example, the first camera 412 can obtain a first captured image frame 432, and the second camera 414 can obtain a second captured image frame 434. In one illustrative example, the stereo image capture system 400 can be used to capture a stereo image pair of a scene including at least the observed point P 450, where the stereo image pair comprises the first captured image frame 432 and the second captured image frame 434.

In some aspects, the pair of cameras 412 and 414 each project the observed point P 450 in their respective or corresponding image planes. For example, the first camera 412 projects the observed point P 450 in the image plane of the first captured image frame 432 as the imaged point p₁. The second camera 414 projects the observed point P 450 in the image plane of the second captured image frame 434 as the imaged point p₂. Based on the horizontal alignment of the first camera 412 and the second camera 414, the first captured image frame 432 and the second captured image frame 434 can be rectified, where the rectification corresponds to the imaged points p₁ and p₂ being located along the horizontal epipolar line 445, with zero vertical disparity between the imaged points p₁ and p₂.

The imaged point p₁ can correspond to the coordinates (x₁, y₁) and the imaged point p₂ can correspond to the coordinates (x₂, y₂). Based on the coordinates for the respective imaged points of the observed point P 450 within the stereo image pair obtained by the cameras 412 and 414 (e.g., the first captured image frame 432 and the second captured image frame 434), disparity information can be determined between the imaged points p₁ and p₂ as δ=|x₁−x₂|. For example, the disparity δ represents a horizontal disparity (HD) between corresponding imaged points p₁ and p₂ within the captured image frames 432 and 434 obtained by the stereo camera pair of cameras 412 and 414 (respectively). The vertical disparity (VD) between corresponding imaged points within the captured image frames 432 and 434 can be equal to zero, based on the horizontal alignment of the cameras 412 and 414, and/or based on performing rectification to vertically align the captured imaged frames 432 and 434.

The depth D from the stereo baseline B to the observed point P 450 within the imaged scene can be determined as

$$D = \frac{fB}{δ} ,$$

where f is the focal length of the cameras 412 and 414, and B is the distance between the optical camera centers of the cameras 412 and 414. In some aspects, the focal length f and stereo baseline B can be obtained by camera calibration, and/or may be included in camera intrinsic information determined corresponding to each respective one of the first camera 412 and the second camera 414 included in the stereo camera pair. In some cases, the disparity δ can be determined based on stereo matching for the stereo image capture system 400.

FIG. 5 is a diagram illustrating an example of an image processing system 500 that can be used to generate a rectified stereo image pair corresponding to a first and second image obtained using a first and second camera, in accordance with some examples. For example, an image capture device 502 can include a plurality of cameras (e.g., a first camera 512, a second camera 514, a third camera 518, etc.). In some cases, a first camera 512 of the image capture device 502 can be used to capture a first image 532 of the stereo pair. The first image 532 can be referred to as a “left” image of the stereo pair, corresponding to output or presentation on a left eye display of an HMD 590, etc. A second camera 514 of the image capture device 502 can be used to capture a second image 534 of the stereo pair. The second image 534 can be referred to as a “right” image of the stereo pair, corresponding to output or presentation on a right eye display of the HMD 590, etc. The first (e.g., left) image 532 obtained by the image capture device 502 can correspond to a left image frame 592 output by the HMD 590, and the second (e.g., right) image 534 obtained by the image capture device 502 can correspond to a right image frame 594 output by the HMD 590. The left frame 592 can also be referred to as a left rectified frame and/or the right frame 594 can also be referred to as a right rectified frame, based on respective rectification image processing performed to generate the left frame 592 and/or the right frame 594 for output by the HMD 590.

In some examples, the image capture device 502 can be included in the image capture and processing system 100, and/or can be the same as or similar to one or more of the image processing device 105B and/or the image capture device 105A of FIG. 1A. In some cases, the image capture device 502 can be the same as or similar to the image capture device 330 of FIG. 3. For example, the first camera 332 of FIG. 3 can be the same as or similar to the first camera 512 of FIG. 5, and the second camera 334 of FIG. 4 can be the same as or similar to the second camera 514 of FIG. 5, etc. In some examples, the first camera 512 of FIG. 5 can be the same as or similar to the first camera 412 of FIG. 4, and the second camera 514 of FIG. 5 can be the same as or similar to the second camera 414 of FIG. 4.

In some cases, the image capture device 502 can include a plurality of cameras that are associated with different respective focal lengths. For example, the first camera 512 can be wide-angle camera associated with a first focal length and corresponding first FOV The second camera 514 can be an ultrawide-angle camera associated with a second focal length and corresponding second FOV, where the second focal length is shorter than the first focal length and the second FOV is wider than the first FOV. In some cases, the third camera 518 can be a telephoto camera associated with a third focal length and corresponding third FOV. The third focal length can be longer than the first or second focal lengths, and the third FOV can be narrower than the first or second FOV.

In some cases, capturing the stereo image pair including the left image 532 and the right image 534 can be performed using two cameras with different respective focal lengths, with at least one of the images cropped to match the FOV depicted in both images of the stereo pair. For example, the first camera 512 can be a wide-angle camera used to capture the left image frame 532 at a corresponding wide-angle FOV (e.g., where the wide-angle FOV is based on the focal length of the wide-angle lens of the first camera 512, etc.). The second camera 514 can be an ultra-wide camera used to capture the right image frame 534 with a shorter focal length and wider FOV, relative to those of the first camera 514 and the left image frame 532.

In some cases, capturing the stereo image pair can include cropping the image obtained by the camera with a shorter focal length (e.g., wider or larger FOV) to match the focal length and FOV of the remaining camera associated with the stereo image pair. In some aspects, the focal length (e.g., and/or corresponding FOV of the camera with the focal length, etc.) can be referred to as a “zoom level” of the camera. In some examples, the focal length and/or corresponding FOV of the camera with the focal length can be used as an input for determining a corresponding zoom level of the camera. In one illustrative example, the right image frame 534 can be a cropped portion of the original image frame captured by the ultrawide camera 514, wherein the cropped portion is cropped to an effective focal length and FOV that match the intrinsic focal length and FOV used by the first camera 512 to capture the left image frame 532. For example, the cropped portion can also be referred to as a “zoomed” portion of the image data, and/or can be referred to as a “zoomed-in” image data or portion of image data. For example, cropping from the FOV and focal length of the originally captured image frame, to a cropped portion having a smaller FOV and longer effective focal length can correspond to zooming in on the originally captured image, by a zoom factor or zoom level adjustment based on the cropping.

In some aspects, both images of a captured stereo image pair can be cropped to a configured zoom level that is different than both a first zoom level (e.g., FOV, focal length, etc.) corresponding to a first, left image of the stereo pair, and a second zoom level (e.g., FOV, focal length, etc.) corresponding to a second, right image of the stereo pair. For example, the two images of a captured stereo image pair may be cropped to a configured third zoom level that is different from the first zoom level, and that is different from the second zoom level. For example, a first image data of the scene (e.g., a left image of the stereo pair) may be obtained by a first camera and using a first zoom level, and can be cropped to the configured third zoom level to generate zoomed first image data. A second image data of the scene (e.g., a right image of the stereo pair) may be obtained by a second camera and using a second zoom level, and can be cropped to the configured third zoom level to generate zoomed second image data. The zoomed first image data and the zoomed second image data can correspond to the same zoom level (e.g., FOV, focal length, etc.) given by the configured third zoom level.

The amount or extent of the respective zooming (e.g., cropping, warping, etc.) performed between the first zoom level and the configured third zoom level can be different than the amount or extent of the respective zooming performed between the second zoom level and the configured third zoom level, for example based on the difference between the first and second zoom levels associated with the two images of the captured stereo image pair. In one illustrative example, the configured third zoom level can correspond to a smaller FOV (e.g., longer focal length) than the respective FOV and focal length associated with both the first image data (e.g., left stereo image) and the second image data (e.g., right stereo image).

For example, the configured third zoom level can be used to crop and/or warp both the left and the right stereo images to generate the respective first and second zoomed image data, where the respective cropping and/or warping performed for the left and right stereo images corresponds to zooming in. In one illustrative example, the configured third zoom level can be a user-configured and/or user-indicated zoom level for a stereo video that includes at least the stereo image pair of the first and second stereo images (e.g., the stereo pair comprising the first and second stereo images is included in a stereo video as a respective stereo video frame, and the configured third zoom level can be determined based on one or more user inputs associated with the capture of the stereo video that are indicative of a desired zoom level).

In some examples, the cropping and focal length or FOV matching between the respective images of the stereo image pair can be performed during capture of the right and left image frames 532 and 534 included in the stereo image pair. As noted above, the cropping and focal length or FOV matching can include generating a respective zoomed image data for both images of the stereo image pair, using a configured third zoom level for the stereo image pair and/or a configured third zoom level for a stereo video including the stereo image pair as a frame of stereo video data. In some aspects, the cropping and focal length or FOV matching can be performed by an image quality (IQ) and frame synchronization engine 540 included in the image processing pipeline of the image processing system 500. The IQ/frame synchronization engine 540 can be used to maintain or control the time synchronization between using the first camera 512 to capture the left image frame 532, and using the second camera 514 to capture the right image frame 534. For example, the first and second cameras 512 and 514, respectively, can be controlled by the IQ/frame synchronization engine 540 to capture the respective image frames 532 and 534 simultaneously and with the same or similar image quality (e.g., IQ).

In some cases, the IQ/frame synchronization engine 540 can adjust exposure and/or capture parameters of the first and/or second cameras 512 and 514 to obtain the left image frame 532 and right image frame 534 with same, similar, or matching IQ. Matching the IQ between the left and right image frames 532 and 534 can correspond to a more effective and/or consistent stereo image pair when viewed by a user of the HMD 590. Synchronizing the capture of the left and right image frames 532 and 534 (e.g., by the IQ/frame synchronization engine 540) can correspond to minimizing or preventing movement within the scene creating discrepancies or differences between the two perspectives imaged by the pair of stereo cameras (e.g., first and second cameras 512 and 514). A lack of synchronization between the capture of the left and right image frames 532 and 534 can be associated with a disorienting viewing experience for a user of the HMD 590 and/or distorted depth effect when viewing the left and right images of an unsynchronized stereo image pair (e.g., as an unsynchronized stereo image pair may correspond to either the left or right eye frames appearing to “lag” relative to the other).

In one illustrative example, the image processing system 500 can include a rectification engine 560 configured to receive a synchronized pair of captured stereo images. The rectification engine 560 can perform rectification to vertically align the stereo image pair (e.g., the received synchronized pair of captured stereo images). Vertically aligning the stereo image pair can correspond to minimizing the vertical disparity between corresponding points or objects depicted in the left image 532 and right image 534. In some cases, rectification can correspond to obtaining zero vertical disparity between corresponding points or objects depicted in the left and right images 532 and 534. For example, the rectification engine 560 can perform rectification such that left and right images 532 and 534 have only horizontal disparity, and no vertical disparity (e.g., as in the example of FIG. 4, with vertical disparity of zero and horizontal disparity of δ between the corresponding imaged points p₁ and p₂ within the stereo image pair).

The rectification engine 560 can perform rectification based on using one image of the stereo pair as a reference image, and warping the remaining image of the stereo pair (e.g., the non-reference image of the stereo pair) to eliminate or minimize any vertical disparity that may be present in the originally captured left and right frames 532 and 534 obtained using the first and second cameras 512 and 514, respectively. In some cases, the captured image frame associated with the longer focal length and/or narrower FOV can be used as the reference frame for rectification (e.g., such as the primary frame 613 of FIG. 6, etc.), and the captured image frame associated with the shorter focal length and/or wider FOV can be used as the auxiliary frame that is rectified and warped to match the reference frame (e.g., such as the auxiliary frame 615 of FIG. 6, which can be rectified and warped to match the reference frame corresponding to primary frame 613 of FIG. 6, etc.). For example, the reference frame can be selected as the first captured image frame 532 obtained using the wide-angle first camera 512 of the image capture device 502, and the auxiliary frame can be the second captured image frame 534 obtained using the ultrawide second camera 514 of the image capture device 502.

In one illustrative example, the rectification engine 560 can generate and output for display by the HMD 590 a rectified stereo image pair comprising a left image frame 592 and a right image frame 594. The left image frame 592 can be generated based on the first captured frame 532 obtained using the first camera 512, and the right image frame 594 can be generated based on the second captured frame 534 obtained using the second camera 514. The rectified stereo image pair comprising the left and right image frames 592 and 594 can have matching IQ, based on one or more IQ adjustments performed by the IQ/frame synchronization engine 540. The rectified stereo image pair 592 and 594 can be rectified to have horizontal disparity only, based on a rectification matrix determined and applied by the rectification engine 560. Based on the rectification performed using the rectification engine 560, the rectified stereo image pair 592, 594 appear as if the two frames 592 and 594 were captured by a stereo pair of cameras separated with only horizontal displacement (e.g., rectification simulates the capture of the two frames 592 and 594 using two stereo cameras that are aligned to have zero relative vertical displacement between their imaging centers). The rectification performed by the rectification engine 560 can correct for lens distortion associated with one or more (or both) of the first camera 512 and/or the second camera 514, and/or can correct for imperfections or inaccuracies in the physical alignment of the cameras 512 and 514 during the manufacture of the image capture device 502, etc. In some examples, the rectification performed by rectification engine 560 can correct for vertical displacement differences between the first and second cameras 512 and 514 corresponding to rotation of the image capture device 502 by the user (e.g., vertical displacement corresponding to the user of image capture device 502 not holding the device perfectly level in the horizontal plane at the time of capturing the stereo image frames 532 and 534, etc.).

In some aspects, the rectified stereo image pair 592, 594 has zero vertical disparity between corresponding points and objects within the scene depicted in the two images 592, 594. The rectified stereo image pair 592, 594 can include a plurality of different horizontal disparity values corresponding to the respective locations of the same point or object in the left rectified frame 592 and the right rectified frame 594.

For example, the depth or distance from a camera imaging sensor to an object within the scene can be determined as

$$D = \frac{fB}{δ} ,$$

which can be reorganized and written as

$$δ = \frac{fB}{D} ,$$

corresponding to decreasing horizontal disparity with the distance from the camera. For example, relatively farther objects or points within the left or right image(s) of a stereo image pair have lower horizontal disparity than relatively closer objects or points within the stereo image pair.

FIG. 6 is a diagram illustrating an example of an image processing system 600 that can be used to generate rectified stereo image pairs using adjustable rectification to implement one or more of an adjustable zoom, an adjustable parallax, and/or object manipulation, in accordance with some examples. The image processing system 600 can be implemented by and/or associated with an image capture device 602 including a plurality of cameras. For example, the image capture device 602 includes a first camera 612 and a second camera 614, which may be the same as or similar to one or more of the first camera 332 and second camera 334 of FIG. 3 (respectively), the first camera 412 and second camera 414 of FIG. 4 (respectively), the first camera 512 and second camera 514 of FIG. 5 (respectively), etc. In some examples, the image capture device 602 can be included in the image capture and processing system 100, and/or can be the same as or similar to one or more of the image processing device 105B and/or the image capture device 105A of FIG. 1A. In some cases, the image capture device 602 can be the same as or similar to the image capture device 330 of FIG. 3, and/or can be the same as or similar to the image capture device 502 of FIG. 5, etc.

In some aspects, the first camera 612 can be configured as a primary camera and/or can be associated with a captured image frame configured as the primary frame of the stereo image pair (e.g., primary frame 613). The second camera 614 can be configured as an auxiliary or non-primary camera, and/or can be associated with a captured image frame configured as the auxiliary or non-primary frame of the stereo image pair (e.g., auxiliary frame 615). In some examples, the first camera 612 is configured as the primary camera for capturing the primary image frame of a stereo image pair, based on the first camera 612 having a longer focal length and/or narrower FOV than the second camera 614. In some cases, the second camera 614 can be configured as the auxiliary (e.g., non-primary) camera for capturing the auxiliary (e.g., non-primary) image frame of the stereo image pair, based on the second camera 614 having a shorter focal length and/or wider FOV than the primary first camera 612.

A stereo image processing pipeline 605 of the image capture device 602 can include a first pipeline for generating and outputting a display preview corresponding to the primary frame 613 captured using the first camera 612. In some aspects, the first pipeline can be an image processing pipeline configured to use the primary frame 613 to generate as output the display preview frame 680. For example, the image capture device 602 can include a display that does not support playback or viewing of stereo images and/or spatial video data, and the HMD 690 can include one or more displays that do support playback or viewing of stereo images and/or spatial video data. In one illustrative example, the image capture device 602 may be a smartphone or mobile device that includes a single display. The HMD 690 can include a first display for outputting a left stereo frame to a left eye of a user and a second display for outputting a right stereo frame to a right eye of the user. Based on the image capture device 602 including a display that is not stereo or spatial-capable, the first image processing pipeline can be configured to generate a non-stereo preview frame corresponding to one image of the two images included in the stereo pair. For example, the first image processing pipeline can generate a non-stereo display preview frame 680 corresponding to the primary frame 613 obtained using the first (e.g., primary) camera 612. In some examples, the non-stereo display preview frame 680 can be generated corresponding to the auxiliary frame 615 obtained using the second (e.g., auxiliary) camera 614.

For example, the first processing pipeline can include an optical flow engine (OFE) 630-1 configured to receive image data associated with a primary frame 613 captured using the first camera 612, and IQ/frame synchronization information generated by an IQ/frame synchronization engine 640 based on image data associated with the auxiliary frame 615 captured using the second camera 614. In one illustrative example, the IQ/frame synchronization engine 640 can be the same as or similar to the IQ/frame synchronization engine 540 of FIG. 5, and can generate and output respective information for synchronization of the IQ and frame timing between the primary frame 613 (e.g., obtained using first camera 612) and the auxiliary frame 615 (e.g., obtained using second camera 614). The preview processing pipeline can include a first image processing engine (IPE) 660-1 configured to perform one or more configured image processing operations (e.g., including various pre-processing stages such as demosaicing, denoising, etc.) and generate and output the display preview frame 680 corresponding to the image data of the primary frame 613.

In some aspects, the stereo image processing pipeline 605 associated with and/or implemented by the image capture device 602 can include the first pipeline comprising the OFE 630-1 and IPE 660-1, configured to perform image processing corresponding to input image data of the primary frame 613 and output image data of the display preview frame 680. For example, the first pipeline can output a display preview frame 680 corresponding to the primary frame 613. The stereo image processing pipeline 605 can include a second pipeline comprising a second IPE 660-2, which can be configured to generate and output a processed left frame (e.g., corresponding to and/or associated with the processed left frame 692 on the HMD 690, etc.), where the processed left frame is associated with the primary frame 613 captured by camera 612. The stereo image processing pipeline 605 can further include a third pipeline which can comprise a second OFE 630-2 configured to process the auxiliary frame 615 image data obtained using the second camera 614, and a third IPE 660-3 configured to perform rectification of the auxiliary frame 615 relative to the primary frame 613 (e.g., where the primary frame 613 is configured as a reference frame for rectifying the auxiliary frame 615).

The second IPE 660-2 and the first IPE 660-1 can be configured as parallel branches from the output of the first OFE 630-1 used to process the primary frame 613 image data from the first camera 612. As noted above, the first IPE 660-1 processes the primary frame 613 image data for output as a display preview frame 680 to a display of the image capture device 602. In some aspects, one or more of the first IPE 660-1, the second IPE 660-2, and/or the third IPE 660-3 can be the same as, similar to, and/or can include one or more components of the IPE 336 of FIG. 3.

The second IPE 660-2 can process the same primary frame image data generated as output of the first OFE 630-1, and can generate a captured frame corresponding to the image data of the primary frame 613 (also referred to as “primary frame 613 image data”) from the first camera 612. For example, the second IPE 660-2 can perform image processing operations to generate a higher quality output than the preview frame 680 generated by the first IPE 660-1, etc. In some cases, the second IPE 660-2 can generate a stabilized captured frame corresponding to the image data of the primary frame 613. For example, the second IPE 660-2 can use stabilization information obtained from an electronic image stabilization (EIS) engine 658 to generate a processed and stabilized captured frame corresponding to the image data of the primary frame 613.

In one illustrative example, the output of the second IPE 660-2 (e.g., the processed and stabilized captured primary frame 613 from first camera 612) can be provided to an encoder 685 as the left frame image data of a stereo image pair. The encoder 685 can receive a right frame image data of the stereo image pair as the output of the third IPE 660-3, and can subsequently generate encoded stereo image pairs for transmission to the MD 690. In some examples, the encoder 685 can generate and transmit encoded spatial video data to the HMD 690, where the encoded spatial video data comprises a plurality of stereo image pairs (e.g., where one frame of the encoded spatial video data comprises one encoded stereo image pair comprising a left frame image data generated by the IPE 660-2 based on the image data of the primary frame 613, and a rectified right frame image data generated by the IPE 660-3 based on the image data of the auxiliary frame 615 (also referred to as “auxiliary frame 615 image data”) and calibration or rectification information from the calibration engine 650). In some aspects, the encoder 685 can be the same as or similar to the encoder 338 of FIG. 3, and for example can be configured to perform MV-HEVC encoding to generate a plurality of encoded frames of spatial video data corresponding to a plurality of stereo image pairs.

In some cases, the third IPE 660-3 can be used to process the image data of the auxiliary frame 615 generated as output of the second OFE 630-2, where the second OFE 630-2 implements respective IQ and frame synchronization adjustments to match the auxiliary frame IQ and/or synchronization (e.g., IQ and/or synchronization information for the auxiliary frame 615) to the primary frame IQ and/or synchronization (e.g., IQ and/or synchronization information for the primary frame 613), based on the IQ frame synchronization information provided from the IQ/frame synchronization engine 640 to the second OFE 630-2.

In one illustrative example, the auxiliary frame 615 image data captured using the second camera 614 of the image capture device 602 can be rectified using the primary frame 613 image data captured using the first camera 612 as a rectification reference (e.g., reference frame for the rectification processing, etc.). For example, the stereo image processing pipeline 605 can include the calibration engine 650, which can be implemented as a real-time calibration (RTC) engine the same as or similar to the RTC engine 339 of FIG. 3 and/or an RTC engine associated with the rectification engine 560 of FIG. 5, etc.

The RTC engine 650 of FIG. 6 can obtain as input the OFE information determined for the primary frame 613 by the first OFE 630-1, and the OFE information determined for the auxiliary frame 615 by the second OFE 630-2. In one illustrative example, the RTC engine 650 can be configured and used to generate information indicative of or corresponding to a rotation matrix R and additional information (e.g., camera intrinsic parameters) that can be used by the third IPE 660-3 to rectify the auxiliary frame 615 to have zero vertical disparity relative to the primary frame 613 configured as reference. In some aspects, the output of the RTC engine 650 can be a rotation matrix R generated and/or determined for rectifying the auxiliary frame 615 to the primary frame 613. For example, the third IPE 660-3 can receive the rotation matrix R and camera intrinsic parameters (also referred to as “camera intrinsic parameter information”) from the RTC calibration engine 650, and the third IPE 660-3 can use the rotation matrix R and camera intrinsic parameter information to perform warping of the auxiliary frame 615 to generate a final rectified frame corresponding to the auxiliary frame 615 image data. In some aspects, the third IPE 660-3 can include and/or implement the rectification engine 560 of FIG. 5, based on performing rectification using the rotation matrix R and camera intrinsic parameter information from the RTC calibration engine 650.

In some aspects, the calibration engine 650 can be a real-time calibration engine configured to perform real-time calibration image processing to dynamically obtain rectified stereo image pairs corresponding to the respective image data or captured frames obtained using the first (e.g., primary) camera 612 and the second (e.g., auxiliary) camera 614 of the image capture device 602. The RTC processing performed by the calibration engine 650 can be different from a factory calibration process or factory calibration information that may be associated with the image capture device 602 and the first and second cameras 612 and 614. For example, the RTC processing can be performed by the calibration engine 650 to analyze image content information or other features corresponding to the imaged scene represented in the primary frame 613 image data and/or the auxiliary frame 615 image data. In some examples, the RTC processing can be used to adapt to changes in the primary frame 613 image data and/or the auxiliary frame 615 image data, including changes associated with other components of the image capture device 602 which may move the lens(es) of the first camera 612 and/or second camera 614 and affect spatial video or stereo image pair rectification (e.g., such as changes caused by OIS and/or EIS components of the image capture device 602, which may be associated with the EIS engine 658, etc.).

In one illustrative example, the calibration engine 650 can perform RTC processing to recalculate a rectification matrix corresponding to the auxiliary frame 615 image data and the primary frame 613 image data. For example, the recalculated rectification matrix can be generated based on updating an initial rectification matrix, with the updates corresponding to the one or more changes associated with the first camera 612 and/or second camera 614.

As noted above, the first camera 612 can be configured as the reference or primary camera for the rectification and RTC processing, and may be selected as the reference or primary camera based on having the smaller FOV of the stereo pair comprising the first camera 612 and the second camera 614. The second camera 614 can be configured as the auxiliary camera that will undergo rectification to eliminate any vertical disparity relative to the reference image of the primary camera 612. The second camera 614 can be configured or used as the auxiliary camera based on having a larger FOV than the primary (first) camera 612. For example, the larger FOV associated with the second camera 614 selected as the auxiliary camera can be used to implement cropping and rotation during the rectification process to match the primary frame 613 from the primary camera 612 having a smaller FOV. In some aspects, the frame(s) of the auxiliary camera 614 (also referred to as “auxiliary camera 614 frame (s)”)(e.g., auxiliary frame 615, etc.) are warped by the IPE 660-3 based on the calibrated rectification matrix determined based on the output of the calibration engine 650 and corresponding RTC processing performed by the calibration engine 650. The warped auxiliary frame 615 image data generated as output by the IPE 660-3 and based on rectification processing applied therein has no vertical disparity relative to the image data of the frame output by the second IPE 660-2.

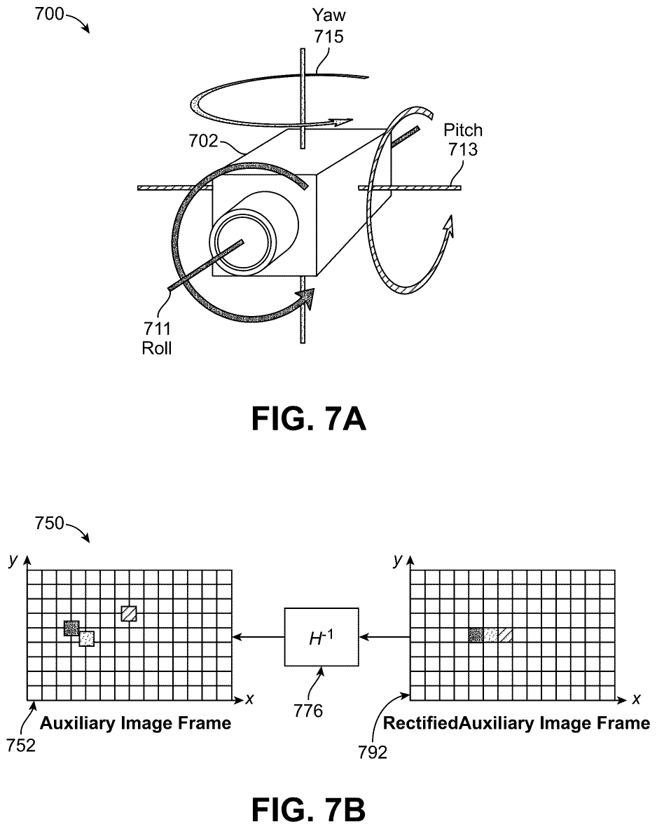

In some cases, rectification processing can be performed by the IPE 660-3, and can include determining the rotation of the auxiliary camera 614 along the x-, y-, and z-axes associated with the auxiliary camera 614 and/or the image capture device 602. In some cases, the x-, y-, and/or z-axes associated with the auxiliary camera 614 and/or the image capture device 602 may be the same as or similar to the respective x-, y-, and/or z-axes associated with the primary camera 612. For example, FIG. 7A is a diagram illustrating the roll, pitch, and yaw axes 700 of a camera 702, in accordance with some examples. The camera 702 can be the same as or similar to the first (e.g., primary) camera 612 and/or the second (e.g., auxiliary) camera 614 of FIG. 6. In some aspects, the x-axis of the auxiliary camera 614 of FIG. 6 can be the same as the roll axis 711 of the camera 702, and the y-axis of the auxiliary camera 614 can be the same as the pitch axis 713 of the camera 702. In some cases, the z-axis of the auxiliary camera 614 of FIG. 6 can be the same as the yaw axis 715 of the camera 702.

In some examples, rectification of the auxiliary camera 614 image data (e.g., auxiliary frame 615, etc.) can be performed by the RTC engine 650 and the IPE 660-3 of FIG. 6 based on a determination of the rotation of the auxiliary camera 614 along its respective x-, y-, and z-axes (e.g., the roll, pitch, and yaw axes of the auxiliary camera 614, which can be the same as the roll axis 711, pitch axis 713, and yaw axis 715, respectively, of camera 702 of FIG. 7A). Based on determining the rotation of the auxiliary camera 614 along its roll, pitch, and yaw axes, rectification can be performed to align the optical axis of the auxiliary camera 614 and the optical axis of the primary camera 612, and to align the respective imaging planes of the auxiliary camera 614 and the primary camera 612 to be coplanar. Based on the alignment of the optical axes and imaging planes of the auxiliary camera 614 and the primary camera 612, the rectification performed by the RTC engine 650 and/or third IPE 660-3 can be used to ensure that corresponding points in the rectified stereo image pair (e.g., provided to the encoder 685 as input from the second IPE 660-2 and third IPE 660-3) lie along the same horizontal line, eliminating vertical disparities between the two images (e.g., left and right) of the rectified stereo image pair.

In some aspects, the RTC calibration engine 650 and/or IPE 660-3 can be configured to perform rectification of the auxiliary camera 614 image frame (also referred to as “auxiliary camera 614 image data” or similar expressions) according to the process 800 of FIG. 8. For example, FIG. 8 is a diagram illustrating a process 800 for real-time calibration associated with estimation of one or more rotation matrices and/or rectification matrices, in accordance with some examples.

At block 810, the process 800 can include performing scene detection and keypoint matching to extract matching keypoints corresponding to points and/or objects within the stereo input images 802 (e.g., including a pair of stereo input images). In some aspects, the stereo input images 802 may include the primary camera 612 image frame data (also referred to as “primary frame 613 image data” or similar expressions) and the auxiliary camera 614 image frame (also referred to as “auxiliary frame 615 image data” or similar expressions) of FIG. 6, or other stereo input images. In some examples, the scene detection and keypoint matching of block 810 can be implemented by the calibration engine 650 of FIG. 6. The scene detection and keypoint matching can correspond to one or more feature detection algorithms that are used to detect respective keypoints in both the primary camera 612 image frame and the auxiliary camera 614 image frame. From the detected keypoints for the primary image and auxiliary image frames, one or more feature matching techniques can be used to identify the one or more matching keypoints represented within the set of detected keypoints for the primary image, and also represented within the set of detected keypoints for the auxiliary image. In some cases, the one or more feature matching techniques may include brute force matching to compare respective keypoints of the set of detected keypoints for the primary image with respective keypoints the set of detected keypoints for the auxiliary image. In some aspects, the scene detection and keypoint matching can be configured with one or more conditions to filter out the best keypoints, and can be configured to accumulate keypoints for different scenes that can be later used to improve the estimation of rotation matrices. In some cases, the scene detection and keypoint matching of block 810 can be performed for the pair of image frames included in the stereo input images 802, and can be further based on configuration information 805, which may include camera intrinsic information associated with the first and second cameras used to capture the stereo input images 802 (e.g., such as the first camera 612 and second camera 614 of FIG. 6, etc.). The output of the scene detection and keypoint matching of block 810 can be information indicative of matching keypoint pairs (referred to as matching keypoint pairs information 815) corresponding to the stereo input images 802.

At block 820, the process 800 can include scale factor estimation performed based on the matching keypoint pairs information 815. For example, the scale factor estimation of block 820 can be performed to determine scale factor information between a pair of stereo input images 802 that are captured at different zoom levels (e.g., a first zoom level and focal length associated with the first image of the stereo input images 802, and a second zoom level and focal length associated with the second image of the stereo input pair of stereo input images 802). The respective zoom level associated with a first image of the stereo input images 802 and the respective zoom level associated with the second image of the stereo input images 802 can be referred to as a first set of zoom levels, where the first set of zoom levels includes the respective zoom levels for the first image data and the second image data. In some aspects, the scale factor estimation of block 820 can be used to determine a scale factor for scaling the respective images of the stereo input images 802 to have the same scale and/or zoom level. After scaling the stereo input images 802, more accurate disparity measurements can be determined between the respective features or matching keypoint pairs (indicated by the matching keypoint pairs information 815) across the two images of the stereo input images 802 with the scale factor applied to bring both images to the same zoom level.

In some examples, the scale factor estimation of block 820 can be performed to determine an estimated scale factor 825. In some examples, the scale factor estimation can be performed and/or determined using the respective intrinsic information of the first and second cameras used to obtain the first and second images of the stereo input images 802 (i.e., stereo input images). For example, the respective intrinsic information of each camera associated with the stereo input images 802 can include or indicate the camera focal length used to capture the image, and the camera focal length information can be used to determine the estimated scale factor 825 between the two images of the stereo input images 802. In another example, the estimated scale factor 825 can be determined based on dividing the distance between two keypoints in the primary camera/first image of the stereo input images 802, by the distance between the same two keypoints as represented within the auxiliary camera/second image of the stereo input images 802. The two keypoints in the primary camera/first image and the corresponding same two keypoints as represented within the auxiliary camera/second image can be determined using the matching keypoints pairs 815 information.

For example, the matching keypoint pairs (e.g., matching keypoint pairs indicated by the matching keypoints pairs information 815) can be used to estimate the scale factor sc, where the scale factor sc is indicative of the amount by which respective keypoints of the auxiliary camera 614 image frame (e.g., included in the matching keypoint pairs indicated by the matching keypoint pairs information 815) need to be scaled to align with the corresponding, matching keypoints of the primary camera 612 image frame (e.g., also included in the matching keypoint pairs indicated by the matching keypoint pairs information 815). For example, the scale factor sc can be equal to 1 if the zoom level of the primary camera image frame included in the stereo input images 802 is the same as the zoom level of the auxiliary camera image frame included in the stereo input images 802 (e.g., objects are of the same size in both views or image frames of the stereo input images 802). In some cases, the estimated scale factor 825 can be multiplied with all of the keypoints within the auxiliary camera image frame and included in the plurality of matching keypoint pairs indicated by the matching keypoint pairs information 815. Based on the scale factor multiplication of the auxiliary camera image frame, the auxiliary camera image frame is scaled to match the scale or zoom level of the primary camera image frame, and the estimation of the rotation matrix therebetween (e.g., corresponding to block 830 and/or 840) is correct. In some examples, the scale factor estimation of block 820 can be skipped and/or set to an estimated scale factor 825 value of 1 based on receiving as input to the process 800 a pair of stereo input images 802 that are already of the same zoom level.

At block 830, the process 800 can include determining an initial or rough estimate of the rotation matrix R, corresponding to an estimation of pitch and roll rotations of the auxiliary camera 614 image frame relative to the primary camera 612 image frame configured and used as reference for the rectification. In some aspects, the rotation matrix estimation of block 830 can be configured according to a condition 831 that vertical disparity between matching keypoints should be equal to zero and/or should be minimized (e.g., the y-axis coordinate of a matching keypoint of the matching keypoint pair in the primary camera 612 image frame should be equal to the y-axis coordinate of the other one corresponding matching keypoint of the matching keypoint pair in the auxiliary camera 614 image frame). In some aspects, the rotation matrix estimation of block 830 can include estimating pitch and roll information based on minimizing vertical disparity (e.g., using the condition 831). For example, the initial rotation matrix estimation of block 830 can be performed according to the vertical disparity minimization condition 831, which may be represented as:

$${min}_{R} {\sum }_{i} {( {main}_{i}^{y} - sc \cdot {auxiliary}_{i}^{y} )}^{2} \qquad Eq . ( 1 )$$

Here, R represents the initial rotation matrix, sc represents the scale factor, i represents each matching keypoint indicated by the matching keypoints pairs information 815, and y represents the y-axis coordinate of the respective matching keypoint in the primary camera 612 image frame or in the auxiliary camera 614 image frame. In some cases, the estimated scale factor 825 determined at the scale factor estimation block 820 may be further refined during the pitch and roll estimation of block 830, subject to the vertical disparity minimization condition 831. The refined scale factor estimate can be used to determine an updated or refined scale factor estimate value for the estimated scale factor 825. The initial rotation matrix estimation of block 830 corresponding to the minimization of the vertical disparity condition 831 and estimated scale factor 825 can provide an accurate estimate for pitch and roll rotations of the auxiliary camera 614 image frame relative to the primary camera 612 image frame, as the pitch and roll angles are the two angles corresponding to movements of the camera in the vertical direction (e.g., corresponding to rotation of camera 702 about the pitch axis 713 and/or roll axis 711 of FIG. 7A, etc.).

The estimated rotation matrix 835 can be determined at block 830, and can be represented as the 3×3 matrix R given as:

$$R = ( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) \qquad Eq . ( 2 )$$

From the rotation matrix R, roll, pitch, and yaw can be calculated as follows:

$$Roll α = atan 2 ( {r}_{32} , {r}_{33} ) \qquad Eq . ( 3 )$$

$$Pitch β = asin ( - {r}_{31} ) \qquad Eq . ( 4 )$$

$$Yaw γ = atan 2 ( {r}_{21} , {r}_{11} ) \qquad Eq . ( 5 )$$

Here, the term α represents the roll angle, β represents the pitch angle, and γ represents the yaw angle. In some examples, the angles roll α, pitch β and yaw γ may be calculated, determined, or otherwise obtained prior to the estimated rotation matrix 835, and the estimated rotation matrix 835 can be calculated using the roll, pitch, and yaw angles as input:

$$R = {R}_{z} ( γ ) \cdot {R}_{y} ( β ) \cdot {R}_{x} ( α ) \qquad Eq . ( 6 )$$

$$R = ( \begin{matrix}cos γ & - sin γ & 0 \\ sin γ & cos γ & 0 \\ 0 & 0 & 1\end{matrix} ) ( \begin{matrix}cos β & 0 & sin β \\ 0 & 1 & 0 \\ - sin β & 0 & cos β\end{matrix} ) ( \begin{matrix}1 & 0 & 0 \\ 0 & cos α & - sin α \\ 0 & sin α & cos α\end{matrix} ) \qquad Eq . ( 7 )$$

The estimated rotation matrix 835 can be provided as input to block 840 of process 800, which can be configured to perform rotation matrix refinement to estimate and/or refine the yaw angle or yaw rotation of the auxiliary camera 614 image frame relative to the primary camera 612 image frame configured as the reference for the rectification process. For example, using the estimated rotation matrix R 835 from block 830, at block 840 the process 800 can estimate the yaw based on the condition 841 setting the minimum horizontal disparity (HD) in the scene associated with the stereo input images 802 equal to zero (e.g., the minimum horizontal disparity between the auxiliary camera 614 image frame and the primary camera 612 image frame cannot be negative, and at block 840 the yaw can be estimated and/or adjusted according to the minimization condition 841 so that the minimum horizontal disparity in the scene associated with the stereo input images 802 is equal to zero).

Based on the non-negative horizontal disparity condition 841, a new (e.g., updated, refined, etc.) rotation matrix R 845 can be determined, where the refined rotation matrix 845 includes a correct (e.g., more accurate) estimate of the yaw rotation than the initial estimated rotation matrix R 835 determined at block 830. In the refined rotation matrix 845, the yaw estimate is corrected and the matching keypoint pairs (indicated by the matching keypoint pairs information 815) corresponding to closer objects (e.g., objects at a shorter distance D from the primary camera 612 and auxiliary camera 614) have a higher horizontal disparity than the matching keypoint pairs (indicated by the matching keypoint pairs information 815) corresponding to farther objects.

The refined rotation matrix 845 with the corrected yaw estimate can be used as the input rotation matrix for rectification at block 850. In some aspects, the refined rotation matrix 845 is the output provided from the RTC calibration engine 650 of FIG. 6 to the input of the IPE and rectification engine 660-3 of FIG. 6. For example, the IPE and rectification engine 660-3 can perform rectification of the auxiliary camera 614 image frame based on a refined rotation matrix 845 received from the calibration engine 650.

In some cases, the refined rotation matrix 845 (e.g., output of calibration engine 650) can be used to calculate or determine a final rectification matrix H, for example according to:

$$H = K \cdot R \cdot {K}^{- 1} \qquad Eq . ( 8 )$$

Here, R is the rotation matrix (e.g., refined rotation matrix 845), and K is the intrinsic matrix corresponding to the camera intrinsic information 808 for a respective camera (e.g., a respective camera of a stereo camera pair, such as the stereo camera pair comprising the first camera 612 and the second camera 614, etc.). The rotation matrix R and the intrinsic matrix K can correspond to the same camera. The final rectification matrix H can be determined for the same camera that is associated with the rotation matrix R and the intrinsic matrix K. The intrinsic matrix K can be represented as:

$$K = ( \begin{matrix}sc \cdot {f}_{x} & 0 & {c}_{c} \\ 0 & sc \cdot {f}_{y} & {c}_{y} \\ 0 & 0 & 1\end{matrix} ) \qquad Eq . ( 9 )$$

Here, fₓ represents focal length in the x-direction and f_{y} represents focal length in the y-direction (e.g., where the focal lengths fₓ and f_{y} are respective focal lengths of the camera associated with the intrinsic matrix K). The term sc is the scale factor (e.g., estimated scale factor 825). The terms cₓ and c_{y} represent the coordinates of the principal point where the optical axis of the camera intersects the image plane.

In one illustrative example, the rectification matrix H can be determined at block 850, based on the refined rotation matrix 845 and camera intrinsic information 808. The camera intrinsic information 808 can correspond to intrinsic parameters of the respective cameras used to capture the stereo input images 802 (e.g., the primary camera 612 and auxiliary camera 614 of FIG. 6, etc.). In some cases, the camera intrinsic information 808 can be included in the configuration information 805. In some aspects, where the rectification of block 850 is used to perform rectification of the auxiliary camera 614 image frame, the camera intrinsic information 808 corresponds to the respective intrinsic parameters of the auxiliary camera 614, and the intrinsic matrix K of Eq. (9) is associated with the auxiliary camera 614).

In some cases, the inverse of the rectification matrix (e.g., the inverse of the H matrix, or H⁻¹) can be applied to each pixel coordinate of the final rectified auxiliary image frame to determine corresponding pixel coordinates in the original auxiliary image frame, with the corresponding pixel coordinates obtained based on interpolation to thereby obtain the final rectified auxiliary image frame. For example, FIG. 7B is a diagram illustrating an example of backward warping 750 to obtain a final rectified image (e.g., rectified auxiliary image frame 792) using a first image included in a stereo image pair (e.g., auxiliary image frame 752) and a rectification matrix (e.g., the inverse of rectification matrix H, H⁻¹ matrix 776) corresponding to a second image included in the stereo image pair and configured as a reference image, in accordance with some examples.

In one illustrative example, the systems and techniques can be used to perform stereo image processing to generate rectified stereo image pairs using adjustable rectification to implement one or more of an adjustable zoom, an adjustable parallax, and/or object manipulation, in accordance with some examples. For example, the systems and techniques can perform stereo image processing corresponding to enhanced zoom processing and/or zoom capabilities for spatial video comprising a plurality of frames of rectified stereo image pairs. In some aspects, the zoom level adjustments can be implemented using corresponding adjustments to the rectification matrix to zoom in (e.g., increase a zoom level) and/or zoom out (e.g., decrease a zoom level) of the spatial video and rectified stereo image pairs before, during, and/or after capture.

For example, zooming a camera or other image or video capture device corresponds to changing a focal length of the one or more cameras being used to capture image data. Zooming in on a scene corresponds to increasing the focal length, and zooming out on a scene corresponds to decreasing the focal length. In one illustrative example, the systems and techniques can implement zoom level adjustments for spatial video comprising a plurality of rectified stereo image frames based on determining adjusted or updated focal length information corresponding to the change in zoom level (e.g., where the adjusted or updated focal length information corresponds to one or both of the two cameras used to capture the left and right images of the stereo image pair).

For example, the primary camera 612 may have an original focal length f and the auxiliary camera 614 may have an original focal length f₂. Without image processing to adjust the zoom level of the spatial video frames (e.g., stereo image pairs), the auxiliary frame 615 can be cropped and rectified from the shorter focal length f₂ (e.g., wider FOV) to match the focal length f₁ and narrower FOV of the primary image frame 613, as noted above. In some aspects, the primary image frame 613 can be cropped from the original focal length f₁ (e.g., corresponding to a first zoom level) to a configured third focal length f₃, where the focal length f₃ corresponds to a configured third zoom level for zooming the spatial video frames. In some examples, the third focal length f₃ (and/or corresponding third zoom level, etc.) can be obtained from one or more user inputs to the image capture device used to capture and generate the spatial video comprising the plurality of stereo image frames. The primary frame 613 can be cropped from the first zoom level of focal length f₁ to the configured third zoom level of focal length f₃, and the auxiliary frame 615 can be cropped from the second zoom level of focal length f₂ to the configured zoom level of focal length f₃. The cropped first image data resulting from cropping the primary frame 613 from f₁ to f₃ can have the same FOV and effective focal length (e.g., f₃) as the cropped second image data resulting from cropping the auxiliary frame 615 from f₂ to f₃.

In some cases, to implement a zoom level change, the systems and techniques can be configured to determine updated focal length information for one or both of the primary camera 612 and/or the auxiliary camera 614. For example, the updated focal length corresponding to the updated zoom level applied to the primary frame 613 image data can be represented as f₁′, and the updated focal length corresponding to the updated zoom level when applied to the auxiliary frame 615 image data can be represented as f₂′.

The updated focal length value(s) f₁′ and/or f₂′ can be inputted to the real-time calibration process of the calibration engine 650. For example, the updated focal length value(s) f₁′ and/or f₂′ can be inputted to the zoom level adjustment engine 653 included within the RTC calibration engine 650. The zoom level adjustment engine 653 can process the updated focal length value(s) f₁′ and/or f₂′ to determine an updated scale factor sc′ for the auxiliary frame 615 rectification against the primary frame 613 as reference at the updated zoom level. For example, the zoom level adjustment engine 653 can process the updated focal length value(s) f₁′ and/or f₂′ to determine an updated scale factor sc′ using a process the same as or similar to the scale factor estimation at block 820 of FIG. 8 used to determine the estimated scale factor 825. The updated scale factor sc′ determined by the calibration engine 650 and the zoom level adjustment engine 653 can subsequently be used to determine an adjusted rectification matrix corresponding to the updated scale factor sc′, for example following the process 800 at blocks 820-850.

For example, the updated scale factor sc′ can be determined for the updated focal lengths according to block 820 of the process 800 of FIG. 8, and the adjusted rectification matrix corresponding to the zoom level adjustment of the stereo image pair (e.g., spatial video frame) can be determined using the updated scale factor sc′ and updated focal length value(s) f₁′ and/or f₂′ as inputs to Eqs. (8) and (9), as given above, to thereby obtain the adjusted rectification matrix corresponding to the zoom level adjustment. In some aspects, based on inputting the adjusted focal length values f₁′ and f₂′, for the primary camera 612 and the auxiliary camera 614, the calibration engine 650 and the zoom level adjustment engine 653 can be used to generate zoomed-in or zoomed-out views for both the left and right stereo frames (e.g., corresponding to the primary camera 612 and the auxiliary camera 614) while maintaining proper rectification based on the updated rectification matrix calculated according to the updated scale factor sc′ and updated focal lengths f₁′ and f₂′.

In some aspects, the zoom level adjustment can be implemented based on adjusting or modifying the primary and auxiliary camera focal lengths as noted above, and including the updated focal lengths f₁′ and f₂′ in the camera intrinsic information 808 used as input to the rectification performed by the IPE and rectification engine 660-3 and/or the rectification performed by block 850 of process 800 of FIG. 8.

In one illustrative example, for the zoom level adjustment to zoom in or out for a spatial video frame (e.g., a rectified stereo image pair), the camera intrinsic matrix K of Eq. (9) is updated corresponding to the new focal length information f₁′ and f₂′ for the primary camera 612 and auxiliary camera 614 after the zoom level adjustment is implemented. For example, before the zoom level adjustment, the camera intrinsic matrix K is given according to Eq. (7) as

$$K = ( \begin{matrix}sc \cdot {f}_{x} & 0 & {c}_{x} \\ 0 & sc \cdot {f}_{y} & {c}_{y} \\ 0 & 0 & 1\end{matrix} ) .$$

Changing the focal length by a zoom level adjustment causes corresponding changes to the camera intrinsic matrix. For example, a zoom level adjustment to zoom in by a factor of two (e.g., a scale factor sc=2) can correspond to an updated intrinsic matrix given as:

$${K}^{′} = ( \begin{matrix}2 {f}_{x} & 0 & {c}_{x} \\ 0 & 2 {f}_{y} & {c}_{y} \\ 0 & 0 & 1\end{matrix} ) \qquad Eq . ( 10 )$$

In Eq. (10), the updated focal length information corresponds to f₁′=2fₓ and f₂′=2f_{y}. The final rectification matrix for implementing the zoom level adjustment can be calculated based on Eq. (8) and using the updated intrinsic matrix K′ of Eq. (10), to obtain:

$${H}^{′} = {K}^{′} \cdot R \cdot {K}^{′ - 1} \qquad Eq . ( 11 )$$

The term R represents the Rotation Matrix calculated based on performing the real time calibration using calibration engine 650 for a particular focal length. The final rectification matrix H′ for the updated zoom level of Eq. (11) can be used on a zoomed-in auxiliary image frame (e.g., the image frame captured by auxiliary camera 614 at the original focal length f₂ and then cropped to reflect the updated, zoomed-in focal length f′₂) to obtain the zoomed-in rectified auxiliary image frame. After rectification using the updated rectification matrix H′, the zoomed-in primary image frame (e.g., the image frame captured by primary camera 612 at the original focal length f₁ and then cropped to reflect the updated, zoomed-in focal length f′₁) and the zoomed-in rectified auxiliary image frame have the same zero vertical disparity as that of the original (non-zoom level adjusted) primary and rectified auxiliary image frames rectified using the original rectification matrix H. The horizontal disparity information is also maintained in the zoomed in and rectified primary-auxiliary stereo image pair, corresponding to the horizontal disparity information included in the original, non-zoomed rectified primary-auxiliary stereo image pair.

In some aspects, zoom level adjustment can be implemented (e.g., for both zooming-in and zooming-out zoom level adjustments) based on using the same zoom factor for both the primary camera 612 and the auxiliary camera 614. For example, a zoom level adjustment of 2× can be implemented with a 2× zoom factor applied to scale the primary camera 612 focal length and to scale the auxiliary camera 614 focal length. In another example, a zoom level adjustment of 0.5× can be implemented by applying a 0.5× zoom factor to scale both the primary camera 612 focal length and the auxiliary camera 614 focal length. Based on applying the same zoom factor for scaling both the primary camera 612 and the auxiliary camera 614, the objects within the scene appear the same size in both views before the scaling and after the scaling of the zoom level adjustment. After applying the same scale factor to both the primary and auxiliary camera views or image frames cropping, the rectification matrix adjustment of H′ and Eq. (11) is applied to adjust the rectification for the auxiliary camera only, also based on this same zoom level adjustment (e.g., with the zoomed and cropped primary camera 612 image frame again used as the reference for the rectification of the zoomed and cropped auxiliary camera 614 image frame).

In another illustrative example the systems and techniques can be used to perform stereo image processing to generate rectified stereo image pairs using adjustable rectification to implement one or more of an adjustable zoom, an adjustable parallax, and/or object manipulation, in accordance with some examples. For example, the systems and techniques can perform stereo image processing corresponding to parallax adjustment to modify the perceived depth of objects within a scene represented by a stereo image pair and/or a spatial video comprising a plurality of spatial video frames provided as rectified stereo image pairs. In some aspects, the parallax adjustments can be configured as a parallax extension (e.g., increasing the parallax or horizontal disparity between objects, corresponding to a smaller perceived depth of the object(s)). In some aspects, the parallax adjustments can be configured as a parallax contraction or reduction (e.g., decreasing the parallax or horizontal disparity between objects, corresponding to a larger perceived depth of the object(s)).

In some examples, the perceived depth of an imaged scene (e.g., the perceived depth of objects or points such as the observed point P 450 at depth D in the example of FIG. 4, etc.) can be changed based on changing one or more of the stereo baseline distance B, the focal length f and/or the horizontal disparity δ (e.g., based on

$$D = \frac{fB}{δ} ) .$$

In some aspects, the stereo baseline B can be a fixed property of the image capture device or stereo imaging system used to obtain the stereo image pair (e.g., with the baseline B representing the physical distance between the optical centers of the two cameras used to capture the stereo image pair). The focal length f used by one or more (or both) of the two cameras of a stereo imaging system when capturing a particular stereo image pair may also be a property that is fixed or determined at or prior to the time of performing image capture by the two cameras of the stereo image system.

In one illustrative example, the systems and techniques can be used to adjust or modify the disparity (e.g., the horizontal disparity δ of FIG. 4, etc.) prior to capturing a stereo image pair, during the capture of a stereo image pair, and/or after capturing a stereo image pair. For example, the systems and techniques can be used to implement a disparity adjustment or modification based on implementing a corresponding change in the yaw of one or more of the stereo cameras (e.g., based on implementing a change in the relative yaw between the optical imaging axes of the two cameras of the stereo pair).

For example, the parallax adjustment to change the perceived depth of objects within the stereo image scene can be used to move objects or subjects farther from or closer to the viewpoint of the camera and viewer of the spatial video including the processed and rectified stereo image as a frame of the spatial video (e.g., where the viewer of the spatial video may be a user of the HMD 690, etc.). In one illustrative example, depth or perceived depth of objects within the stereo image scene can be adjusted based on changing the yaw of the stereo cameras (e.g., primary camera 612 and auxiliary camera 614) after rectification. For example, in some cases the parallax adjustment can be implemented using one or more of the parallax extension engines 676-1, 676-2, and/or 676-3 of the stereo image processing pipeline 605 of FIG. 6.

Rectification of the auxiliary camera 614 image frame is performed by the IPE and rectification engine 660-3, and the yaw angle change may be implemented by the parallax extension engine 676-3 after the initial rectification has been performed by the IPE and rectification engine 660-3. In some aspects, parallax extension processing can be performed for the output primary camera 612 image frame by the parallax extension engine 676-2 (e.g., based on the parallax extension engine 676-2 receiving from the IPE engine 660-2 the processed output image frame for the primary camera 612). In another example, parallax extension processing can be performed for the output of the display preview frame 680 from the first IPE 660-1, based on using the parallax extension engine 676-1 to perform the yaw manipulation on the display preview frame 680 image data corresponding to the primary frame 613 image data obtained from the primary camera 612.

In some examples, the parallax adjustment can be performed prior to the rectification implemented by the IPE and rectification engine 660-3. For example, in some cases the calibration engine 650 can include a parallax extension engine 657 that can perform the parallax adjustment based on increasing or decreasing the yaw angle between the primary camera 612 and auxiliary camera 614. The parallax extension engine 657 can be the same as or similar to one or more of the parallax extension engines 676-1, 676-2, and/or 676-3.

In some aspects, the parallax extension processing can be implemented by one or more of the parallax extension engines 676-1, 676-2, and/or 676-3, and/or 657 of the stereo image processing pipeline 605 associated with the image capture device 602; and/or implemented by the parallax extension engine 696 of the HMD image processing system 695 of the HMD 690, etc.

Changing the yaw angle between the primary camera 612 and the auxiliary camera 614 can correspond to calculating a rotation matrix for a converging or diverging configuration between the two cameras. A parallel configuration between the two cameras (e.g., neither converging nor diverging) can correspond to the optical axes of the primary camera 612 and auxiliary camera 614 being parallel, which can be a yaw angle of 0 degrees between the two cameras. A converging or diverging configuration between the two cameras can correspond to a non-zero value of the yaw angle γ (e.g., and angular rotation about the yaw axis 715 of the camera 702 of FIG. 7A, etc.).

As noted above, from the Rotation Matrix

$$R = ( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) ,$$

the respective roll, pitch, and yaw angles can be obtained as follows:

$$Roll α = atan 2 ( {r}_{32} , {r}_{33} )$$

$$Pitch β = asin ( - {r}_{31} )$$

$$Yaw γ = atan 2 ( {r}_{21} , {r}_{11} )$$

A change in the parallax can be implemented by one or more of the parallax extension engines 676-1, 676-2, 676-3, 657, and/or 696 of FIG. 6, and can be determined using the addition of an offset to the yaw angle. The yaw angle offset value can be a configured value (e.g., including a user-configured or user-adjust value, etc.) indicative of the extent and the direction of the change of the stereo camera configuration away from parallel configuration. A positive yaw angle offset can correspond to diverging optical axes of the primary camera 612 and auxiliary camera 614, with larger positive values of the yaw angle offset corresponding to greater and greater divergence. A negative yaw angle offset can correspond to converging optical axes of the primary camera 612 and auxiliary camera 614, with smaller negative values of the yaw angle offset corresponding to greater and greater convergence.

Based on the configured yaw angle offset for the desired yaw angle adjustment (e.g., corresponding to the desired parallax adjustment), an updated yaw angle for the auxiliary camera can be represented as γ″, which can be determined according to:

$${γ}^{″} = γ + offset \qquad Eq . ( 12 )$$

The rotation matrix R can be updated according to Eq. (6), using the initial values determined for the roll angle α and the pitch angle β, and using the updated yaw angle for the parallax adjustment, γ″ of Eq. (12):

$$R = {R}_{z} ( γ ) \cdot {R}_{y} ( β ) \cdot {R}_{x} ( α ) \qquad Eq . ( 6 )$$

$$R = ( \begin{matrix}cos {γ}^{″} & - sin {γ}^{″} & 0 \\ sin {γ}^{″} & cos {γ}^{″} & 0 \\ 0 & 0 & 1\end{matrix} ) ( \begin{matrix}cos β & 0 & sin β \\ 0 & 1 & 0 \\ - sin β & 0 & cos β\end{matrix} ) ( \begin{matrix}1 & 0 & 0 \\ 0 & cos α & - sin α \\ 0 & sin α & cos α\end{matrix} ) \qquad Eq . ( 13 )$$

An updated rectification matrix H″ can be determined based on updating Eq. (8) using the rotation matrix R″ corresponding to the yaw angle adjustment γ″ to obtain:

$${H}^{″} = K \cdot {R}^{″} \cdot {K}^{- 1} \qquad Eq . ( 14 )$$

The auxiliary camera 614 image can be processed using the updated rectification matrix H″ of Eq. (14) to obtain an adjusted rectified auxiliary image frame with exaggerated yaw between the stereo camera pair (e.g., primary camera 612 and auxiliary camera 614) corresponding to the configured yaw offset change used in Eq. (12) to increase the yaw into a diverging configuration between the optical axes of the stereo camera pair, or used to decrease the yaw into a converging configuration between the optical axes of the stereo camera pair.

The adjusted parallax processing for the primary camera 612 and corresponding primary image frame can be implemented to change the yaw used for the primary camera 612, based on the yaw angle for the primary camera 612 being configured with the same magnitude (e.g., same value) as the yaw angle for the auxiliary camera 614, but with the opposite sign. For example, the respective yaw angle for the primary camera 612 can be the same value and opposite sign from the respective yaw angle for the auxiliary camera 614, in both the converging and diverging parallax/yaw adjustment cases. For example, the primary camera 612 yaw angle can be given as:

$${γ}_{m}^{″} = 0 - offset = - offset \qquad Eq . ( 15 )$$

A rectification matrix for the primary camera 612 may be calculated as Hₘ″, and can be used to rotate the primary camera 612 through the same yaw angle offset (e.g., of Eq. (12)) magnitude as the auxiliary camera 614, but in the opposite direction. For example, the rectification matrix Hₘ″ for the primary camera 612 can be determined as:

$${H}_{m}^{″} = {K}_{m} \cdot ( \begin{matrix}cos {γ}_{m}^{″} & - sin {γ}_{m}^{″} & 0 \\ sin {γ}_{m}^{″} & cos {γ}_{m}^{″} & 0 \\ 0 & 0 & 1\end{matrix} ) \cdot {K}_{m}^{- 1} \qquad Eq . ( 16 )$$

Here, Kₘ represents the intrinsic matrix corresponding to the camera intrinsic parameters or information associated with the primary camera 612.

In some aspects, the yaw angle adjustment for parallax adjustment of the rectified stereo image pair (e.g., spatial video frame) can be implemented based on determining the updated rectification matrix H″ to rotate the auxiliary frame 615 through a yaw angle offset corresponding to the converging or diverging adjustment between the pair of stereo cameras. The updated rectification matrix H″ indicative of the changed yaw angle for the auxiliary camera, γ″, can be determined by the parallax extension engine 657 of the calibration engine 650 and may be applied by the IPE and rectification engine 660-3 used to process the auxiliary frame 615 image data. In some aspects, the updated rectification matrix H″ indicative of the changed yaw angle for the auxiliary camera, γ″, can be determined by the parallax extension engine 676-3, and fed back to the IPE and rectification engine 660-3 to update the processed auxiliary frame 615 image data using the yaw/parallax-adjusted updated rectification matrix H″.

In some examples, only the auxiliary frame 615 image data is adjusted for the yaw angle change to implement the parallax extension to the converging or diverging configuration (e.g., and the primary frame 613 image data is not rectified and remains in the initial, approximately zero or exactly zero-valued yaw angle orientation). In some aspects, the primary frame 613 image data can be rectified to implement a corresponding yaw angle change of the same magnitude and opposite direction as applied for the auxiliary frame 615. For example, the display preview frame pipeline parallax extension engine 676-1 can determine the updated yaw angle γₘ″ for the primary frame 613 and may calculate and apply the corresponding yaw adjustment rectification matrix Hₘ″ to the primary frame 613 image data in the display preview output pipeline (e.g., the image processing pipeline associated with and/or configured to generate as output the display preview frame 680, etc.). In another example, the primary frame 613 image data can be processed by the capture pipeline IPE 660-2, and can be rectified by the parallax extension engine 676-2 using an updated yaw angle γₘ″ and corresponding yaw adjustment rectification matrix Hₘ″ that may be determined for the primary camera 612 by the parallax extension engine 676-2 included in the primary camera image capture pipeline that includes the IPE 660-2 and the parallax extension engine 676-2.

In one illustrative example, when the stereo image processing pipeline 605 of FIG. 6 is configured without any parallax extension (e.g., when a parallax extension adjustment is not made to the processed rectified stereo image pair corresponding to the original frame 613 and auxiliary frame 615), only the auxiliary frame 615 image data is rectified, using the rectification matrix H=K·R·K⁻¹ of Eq. (8). In this example, no rectification matrix is determined or applied to the primary frame 613 image data, and the auxiliary frame 615 image data is rectified using the primary frame 613 image data as the reference during rectification. In some aspects, the primary frame 613 being processed without a rectification matrix can be the same as setting the primary camera 612 rectification matrix to be identity, Hₘ=I.

In one illustrative example, when the stereo image processing pipeline 605 is configured to use or perform the parallax extension processing to change the yaw angle and increase or decrease the apparent parallax and perceived depth of objects within the stereo image scene, the configured yaw offset value ‘offset’ of Eq. (12) can be obtained (e.g., from a user, from a stored configuration, automatically determined, etc.) and used as input to compute new rectification matrices for both the primary camera 612 and the auxiliary camera 614. As noted above, the offset angle can be a parameter that varies corresponding to how much (e.g., the extent to which) the user wants the camera angle to diverge or converge between the stereo camera pair of the primary camera 612 and auxiliary camera 614. For the auxiliary camera 614, the parallax/yaw-adjusted rectification matrix H″ is determined as H″=K·R″·K⁻¹ for example according to Eq. (14). For the primary camera 612, the parallax/yaw-adjusted rectification matrix Hₘ″ is determined as

$${H}_{m}^{″} = {K}_{m} \cdot ( \begin{matrix}cos {γ}_{m}^{″} & - sin {γ}_{m}^{″} & 0 \\ sin {γ}_{m}^{″} & cos {γ}_{m}^{″} & 0 \\ 0 & 0 & 1\end{matrix} ) \cdot {K}_{m}^{- 1} ,$$

according to Eq. (16) and using the primary camera 612 intrinsic matrix Kₘ.

In some aspects, the parallax adjustment based on implementing a corresponding yaw angle change for one or both of the primary frame 613 and auxiliary frame 615 image data can be used to flexibly adjust on the fly the depth of spatial video frames comprising rectified stereo image pairs. In one illustrative example, the depth adjustments corresponding to the parallax and yaw angle changes can be used instead of obtaining a depth map 620 or other depth information for the stereo image scene and re-projecting by adjusting the disparity, and/or can be used instead of recapturing the scene at the different parallax, and/or can be used instead of physically modifying the stereo camera setup as shown in FIG. 4, etc. (e.g., corresponding to changes in the physical configuration of the two cameras, including to the baseline distance B and/or yaw angles or rotations of the camera lens and optical axis to converge or diverge prior to capturing the stereo image pair of the scene).

In some examples, parallax extension modifications and/or zoom level adjustments described above can be performed during image preview processing corresponding to the IPE 660-1, the output of one or more display preview frames (e.g., display preview frame 680, etc.) from the IPE 660-1, and preview processing pipeline operations using image data associated with the primary camera 612 as input. For example, parallax extension adjustments can be performed during the preview, while recording spatial video comprising a plurality of spatial video frames each comprising a rectified and processed stereo image pair of left and right images from the primary camera 612 and auxiliary camera 614, respectively.

In some aspects, the parallax extension modifications and/or zoom level adjustments can be performed after recording a spatial video comprising a plurality of spatial video frames each comprising a rectified and processed stereo image pair of left and right images from the primary camera 612 and auxiliary camera 614, respectively. For example, the parallax extension modifications and/or zoom level adjustments can be implemented as postprocessing operations after the spatial video data and plurality of frames of stereo image pairs have been saved.

In some cases, the parallax extension modification performed using one or more of the parallax extension engines 657, 676-1, 676-2, 676-3, and/or 696 can be implemented based on modifying only the R matrix or matrices (e.g., rotation matrix or matrices), and with the modification to the R matrix corresponding also to a subsequent modification of the rectification matrices H determined for the auxiliary camera 614 and/or the primary camera 612.

In examples where parallax extension processing is performed after recording of a spatial video (e.g., after capture of a plurality of spatial video frames comprising a plurality of stereo image pairs rectified in an initial configuration of parallel, converging, or diverging parallax), the post-processing parallax extension processing can be performed based on re-rectifying the frames of stereo image pairs with the new R and H matrices corresponding to the changed yaw angle for the primary camera 612 and/or auxiliary camera 614.

In some aspects, rectification and/or stereo image processing, or portions thereof, can be performed on the display-side of the stereo image processing system, for example based on the HMD 690 (e.g., a display device associated with the image capture device 602 and the stereo image processing pipeline 605) including the HMD image processing system 695 that can be used to perform some or all of the stereo image processing operations associated with the stereo image processing pipeline 605.

For example, the encoder 685 can be used to transmit to the HMD 690 (e.g., where the HMD 690 includes a corresponding decoder, such as the decoder 319 of the HMD 310 associated with the image capture device 330 in the split-XR architecture system 300 of FIG. 3) encoded spatial video data and/or spatial video information corresponding to the plurality of rectified stereo image pairs generated by the stereo image processing pipeline 605 as respective frames of the spatial video. For example, the encoded spatial video information received by the HMD 690 from the encoder 685 can include a plurality of stereo image pairs (e.g., obtained at or corresponding to the frame rate of the spatial video, where each stereo image pair of the plurality of stereo image pairs comprises a respective primary camera 612 image frame and a respective auxiliary camera 614 image frame).

The encoded spatial video information can additionally include metadata or meta information including and/or indicative of one or more of rotation matrix (e.g., R matrix) information for the stereo image pairs (e.g., roll, pitch, and yaw angles), camera intrinsic parameters associated with capturing the stereo image pairs, etc. In some aspects, the encoded spatial video information can include segmentation maps or segmentation information corresponding to the stereo image pairs. In some examples, the encoded spatial video information can include depth maps or depth information corresponding to the stereo image pairs, for example the depth map 620.

Based on receiving the encoded spatial video information from the encoder 685 associated with the image capture device 602 and stereo image processing pipeline 605, the HMD 690 can use the HMD image processing system 695 to optionally perform some or all of the processing associated with the parallax extension and/or object manipulation of the stereo image pair frames, to obtain the processed left stereo image frame 692 and the processed right stereo image frame 694 for output on the HMD 690 during presentation of the spatial video to a user of the HMD 690. For example, the HMD image processing system 695 can include a parallax extension engine 696, which may be the same as or similar to one or more of the parallax extension engines 657, 676-1, 676-2, and/or 676-3 of the stereo image processing pipeline 605. In some aspects, the HMD image processing system 695 can include an object manipulation engine 697 that may be the same as or similar to one or more of the object manipulation engines 672-1, 672-2, and/or 672-3 of the stereo image processing pipeline 605.

In another illustrative example, the systems and techniques can be used to perform object manipulation to remove, reposition, and/or resize one or more selected objects within the scene associated with a stereo image pair (e.g., a frame of spatial video, etc.). For example, the object manipulation processing can be performed during the capture and processing of the stereo image pairs used as the frames of the spatial video output, for example using one or more of the object manipulation engine 672-1 (e.g., associated with object manipulation for the display preview output pipeline configured to generate the display preview frame 680 using image data of the primary frame 613), the object manipulation engine 672-2 (e.g., associated with object manipulation for the capture pipeline corresponding to image data of the primary frame 613), and/or the object manipulation engine 672-3 (e.g., associated with object manipulation for the capture pipeline corresponding to image data of the auxiliary frame 615).

In one illustrative example, the object manipulation engines 672-1, 672-2, and 672-3 may be the same as or similar to one another. In some aspects, the object manipulation engines 672-1, 672-2, and 672-3 may be the same as or similar to the object manipulation engine 697 implemented by the HMD image processing system 695 of the HMD 690. In some cases, the object manipulation engines 672-1, 672-2, and 672-3 (e.g., including segmentation engines and inpainting engines described herein) may be separate as shown in FIG. 6, or a single engine can serve as the object manipulation engines 672-1, 672-2, and 672-3. Similar understanding may also apply to the parallax extension engines 676-1, 676-2, and 676-3.

In some aspects, the object manipulation engines 672-1, 672-2, 672-3, and/or 697 can be used to perform object removal to remove one or more objects from the final 3D scene that is generated as output for display on the HMD 690 to a user. For example, objects can be removed from the frames of the spatial video based on performing object removal for each stereo image pair comprising a spatial video frame. In one illustrative example, object removal can correspond to using the object manipulation engines 672-1, 672-2, 672-3, and/or 697 to remove an identified object from each of the left camera frames (e.g., primary frame 613 and/or other frames of image data obtained using the primary camera 612) and the right camera frames (e.g., auxiliary frame 615 and/or other frames of image data obtained using the auxiliary camera 614) included in a stereo image pair configured as a frame of the spatial video.

For example, segmentation engines and inpainting engines can be implemented and run individually on the left camera (e.g., primary camera 612) image frames and the right camera (e.g., auxiliary camera 614) image frames, to determine segmentation information indicative of the particular pixels or pixel regions corresponding to an object configured for removal. The segmentation engines for the left and right camera frames can be used to identify the pixels corresponding to the object configured for removal, and the object manipulation engines can remove the identified pixels based on the segmentation information. The object manipulation engines can additionally include individual inpainting engines for the left and right image frames, which can be used to perform inpainting to the particular pixels or pixel regions corresponding to or associated with the removed object.

Each of the object manipulation engines 672-1, 672-2, 672-3, and 697 can include at least one segmentation engine or segmentation machine learning network, configured to perform segmentation for a left or right stereo image frame received as input. Each of the object manipulation engines 672-1, 672-2, 672-3, and/or 697 can additionally include at least one inpainting engine or inpainting machine learning network, configured to perform inpainting for a left or right stereo image frame received as input.

For example, the object manipulation engines 672-1 and 672-2 are associated with processing image data associated with the left (e.g., primary camera 612) image frame of the stereo pair, and can each include a respective segmentation engine or ML network and a respective inpainting engine or ML network for processing the left (e.g., primary camera 612) image frames. The object manipulation engine 672-3 is associated with processing image data associated with the right (e.g., auxiliary camera 614) image frame of the stereo pair, and can include a respective segmentation engine or ML network and a respective inpainting engine or ML network for processing the right (e.g., auxiliary camera 614) image frames.

In some aspects, the object manipulation engine 697 of the HMD image processing system 695 implemented by the HMD 690 can include separate segmentation engines or ML networks for the left and right stereo images of each stereo pair received in the encoded spatial video data, and can include separate inpainting engines or ML networks for the left and right stereo images of each stereo pair as well.

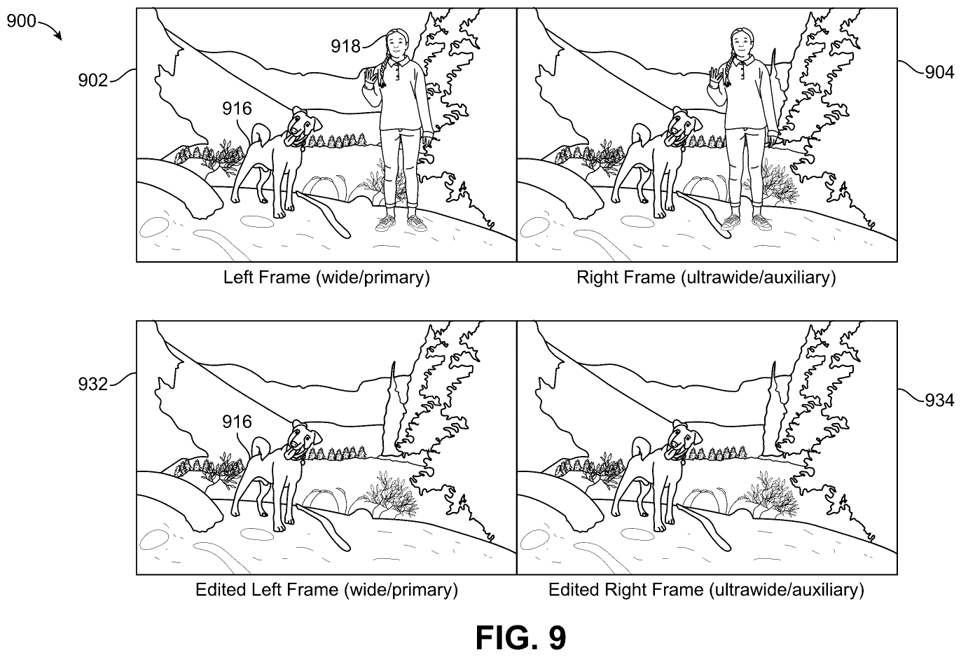

For example, FIG. 9 is a diagram illustrating an example of object manipulation 900 to remove and/or reposition one or more objects within a three-dimensional (3D) scene corresponding to a plurality of stereo image pairs configured as a plurality of frames of spatial video, in accordance with some examples. A left image frame 902 can be associated with a left camera of a stereo camera pair (e.g., such as the primary camera 612 of FIG. 6, etc.). A right image frame 904 can be associated with a right camera of the stereo camera pair (e.g., such as the auxiliary camera 614 of FIG. 6, etc.).

In some cases, the left frame 902 is configured as the primary frame of the stereo image pair (e.g., corresponding to the primary frame 613 of FIG. 6, etc.), and is obtained using a wide-angle camera, and the right frame 904 is configured as the auxiliary frame of the stereo image pair (e.g., corresponding to the auxiliary frame 615 of FIG. 6, etc.), and is obtained using an ultrawide camera. The left frame 902 and right frame 904 depict corresponding representations of the same scene, as captured by the wide (e.g., primary) and ultrawide (e.g., auxiliary) cameras of a multi-camera image capture device (e.g., such as the image capture device 602 of FIG. 6, etc.). Both the left frame 902 and the right frame 904 include the same two objects or subjects, shown in FIG. 9 as the first object/subject 916 (e.g., a dog) and the second object/subject 918 (e.g., a person).

In some aspects, the unwanted objects can be removed based on segmentation information and/or other instance identification information (e.g., determined based on one or more of segmentation maps, depth maps, face detection information, torso detection information, depth estimation information, pose estimation information, gaze estimation information, etc.) indicative of the pixels or pixel locations that correspond to each respective unwanted object that is to be removed.

Inpainting can be performed to replace the pixels corresponding to unwanted subjects with generated pixels determined based on contextual information of neighboring pixels and/or neighboring portions of the imaged scene. In some examples, the inpainting can be performed using one or more inpainting machine learning networks provided by the stereo image processing pipeline 605 and/or the HMD image processing system 695 of FIG. 6. For example, an image completion and inpainting engine (e.g., also referred to herein as the inpainting engine) can be configured to generate inpainted image regions to replace the pixels that are deleted or removed during the removal of unwanted subjects within the respective left or right image frame. For example, an inpainting machine learning network and/or the image completion and inpainting engine can be used to generate image data for the missing portion(s) of the image frame that correspond to the removed, unwanted subject(s). The inpainting machine learning network and/or the image completion and inpainting engine can be used to generate image data for the missing portion(s) within the image frame, by generating new pixel data to fill the negative space corresponding to the removed, unwanted subject(s). The generated pixel data from the inpainting machine learning network and/or the image completion and inpainting engine can be generated based on analyzing pixel information, semantic information, etc., of neighboring pixels that were not removed from the image frame, and/or based on analyzing pixel information, semantic information, etc., of non-removed background portions of the image frame.

Using the individual segmentation and inpainting engines for the left frame 902 and the right frame 904, corresponding edited left frame 932 can be generated by using the segmentation engine to remove the pixels of the object/subject 918 (e.g., the person) from the left frame 902 and subsequently using the inpainting engine to generate new replacement pixels for the removed region previously occupied by the object/subject 918 (e.g., the person). After segmentation and inpainting for the left frame 902, the edited left frame 932 can be generated as the output of the object manipulation for the left frame and/or primary camera. In some cases, the edited left frame 932 can be generated as output by the object manipulation engine 672-1 of FIG. 6, for example where the edited left frame 932 is a display preview frame (e.g., such as the display preview frame 680 of FIG. 6, etc.). In another example, the edited left frame 932 can be generated as output by the object manipulation engine 672-2 of FIG. 6, in examples where the edited left frame 932 is the captured frame for the primary camera 612, etc. Based on not being configured or selected for removal or object manipulation, the object/subject 916 (e.g., the dog) remains the same in the un-edited left frame 902 and the edited left frame 932.

Using the individual segmentation and inpainting engines for the right frame 904, corresponding edited right frame 934 can be generated by using the segmentation engine to remove the pixels of the object/subject 918 (e.g., the person) from the right frame 904 and subsequently using the inpainting engine to generate new replacement pixels for the removed region previously occupied by the object/subject 918 (e.g., the person). After segmentation and inpainting for the right frame 904, the edited right frame 934 can be generated as the output of the object manipulation for the right frame and/or auxiliary camera. For example, the edited right frame 934 can be generated as output by the object manipulation engine 672-3 of FIG. 6, based on the edited right frame 934 being a captured frame for the auxiliary camera 614, etc. Based on not being configured or selected for removal or object manipulation, the object/subject 916 (e.g., the dog) remains the same in the un-edited right frame 904 and the edited right frame 934.

In some aspects, object manipulation to remove unwanted objects from the final 3D scene of a spatial video, spatial photo, stereo image pair, etc., can be done during capture of the stereo image pair by the primary camera 612 and auxiliary camera 614 (e.g., before output of the encoded spatial video data from encoder 685 to the HMD 690, and/or before output of the final left-right output stereo pair of frames 692, 694 for display to a user of the HMD 690, etc.). In another illustrative example, object manipulation to remove unwanted objects from the final 3D scene of a spatial video, spatial photo, stereo image pair, etc., can be performed after capture as post-processing operations performed using the image capture device 602 and associated stereo image processing pipeline 605. In another example, object manipulation to remove unwanted objects from the final 3D scene of a spatial video, spatial photo, stereo image pair, etc., can be performed after capture as post-processing operations performed using the HMD 690 and associated HMD image processing system 695 and/or object manipulation engine 697, etc.

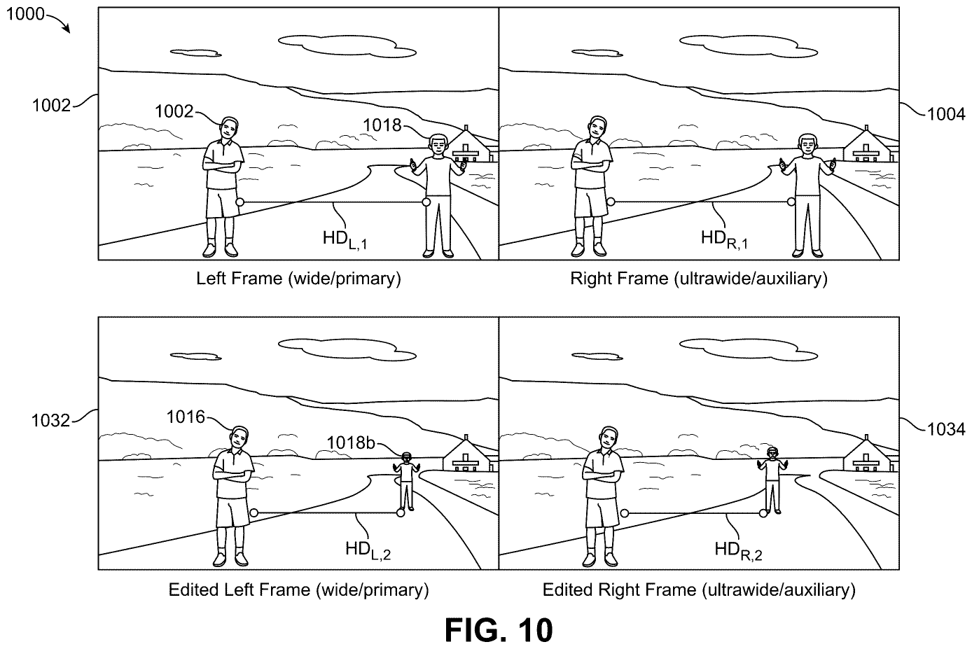

In another illustrative example, the systems and techniques can use the object manipulation engines 672-1, 672-2, 672-3, and/or 697 to reposition and/or move and/or resize one or more objects within the 3D scene associated with spatial video, spatial photo, and/or stereo image pair capture and processing, etc. For example, an object can be selected or configured by a user for repositioning, resizing, moving, or various other object manipulation operations. In some aspects, the object selection can be based on using segmentation information to determine the corresponding pixels for the object in each of the left and right stereo images. For example, FIG. 10 is a diagram illustrating another example of object manipulation 1000 to remove and/or reposition one or more objects within a 3D scene corresponding to a plurality of stereo image pairs configured as a plurality of frames of spatial video, in accordance with some examples.

A left image frame 1002 can be associated with a left camera of a stereo pair (e.g., such as the primary camera 612 of FIG. 6, etc.). In some cases, the left image frame 1002 can correspond to the primary frame 613 image data of FIG. 6. A right image frame 1004 can be associated with a right camera of the stereo pair (e.g., such as the auxiliary camera 614 of FIG. 6, etc.). In some cases, the right image frame 1004 can correspond to the auxiliary frame 615 image data of FIG. 6. In some cases, the left frame 1002 is configured as the primary frame of the stereo image pair, and is obtained using a wide-angle camera, and the right frame 1004 is configured as the auxiliary frame of the stereo image pair, and is obtained using an ultrawide camera. The left frame 1002 and right frame 1004 depict corresponding representations of the same scene, as captured by the wide (e.g., primary) and ultrawide (e.g., auxiliary) cameras of a multi-camera image capture device (e.g., such as the image capture device 602 of FIG. 6, etc.). Both the left frame 1002 and the right frame 1004 include the same two objects or subjects, shown in FIG. 10 as the first object/subject 1016 (e.g., a first person) and the second object/subject 1018 (e.g., a second person).

The horizontal distance between the subjects 1016 and 1018 within the un-edited left frame 1002 is equal to HD_{L,1} and the horizontal distance between the same two subjects 1016 and 1018 within the un-edited right frame 1004 is equal to HD_{R,1}. In some aspects, the horizontal disparity associated with the un-edited left and right frames 1002, 1004 is the difference between the two horizontal distances HD_{L,1} and HD_{R,1}.

In the edited left frame 1032 and the edited right frame 1034, the object manipulation engines 672-1, 672-2, 672-3, and/or 697 can be used to reposition the second subject 1018 along the depth dimension of the stereo image pair. For example, to cause a user or viewer of the stereo image pair to perceive the second subject 1018 as being farther away (e.g., at a greater depth or distance from the stereo cameras), the second subject 1018 is resized to be smaller and moved to a different position within the scene depicted in the stereo image pair of the left frame 1002 and right frame 1004. For example, the pixels corresponding to the second subject 1018 can be identified in the un-edited left frame 1002 using a segmentation engine running in the object manipulation engine 672-1 and/or 672-2 used for processing left frame (e.g., primary camera 612) image data, as described above. The segmented pixels of the second subject 1018 can be scaled down to implement the resizing operation, as more distance subjects will appear smaller in the image frame of the scene. The inpainting engine(s) described above can be used to perform inpainting to replace the pixels occupied by the second subject 1018 in the original, un-edited left frame 1002. A corresponding process can be performed to segmented, reposition, resize, and perform inpainting for the right frame 1004.

In the edited left frame 1032, the first subject 1016 is unedited, while the second subject now appears as more distant from the camera, at a smaller size and different position within the edited left frame 1032. The manipulated second subject 1018b is positioned at a horizontal distance HD_{L,2} from the first subject 1016, in the edited left frame 1032. Similarly, in the edited right frame 1034, the first subject 1016 is unedited, while the second subject now appears as more distant from the camera, at a smaller size and different position within the edited right frame 1034. The manipulated second subject 1018b is positioned at a horizontal distance HD_{R,2} from the first subject 1016, in the edited right frame 1034.

In some cases, the object manipulation engines of FIG. 6 can be used to reposition one or more objects based on movement in any combination of up, down, left, and/or right within the scene of the left and right stereo images (e.g., left frame 1002 and right frame 1004, etc.). The object manipulation engines of FIG. 6 can further be used to reposition one or more objects based on movement closer or farther from the stereo cameras used to capture the scene of the left and right stereo images (e.g., left frame 1002 and right frame 1004, etc.).

In one illustrative example, to change the depth of the object of interest, the repositioning within the edited left frame 1032 and the edited right frame 1034 can be implemented using an updated horizontal disparity value that is increased or decreased relative to other objects in the scene. For example, the updated horizontal disparity between HD_{L,2} and HD_{R,2} in the edited left and right frames 1032, 1034 (respectively) can be smaller than the horizontal disparity between HD_{L,1} and HD_{R,1} in the un-edited left and right frames 1002, 1004 (respectively), based on the observation that horizontal disparity decreases for objects that are farther away from the stereo cameras (e.g., decreases for objects that are at a greater depth within the scene of the stereo image pair).

In some cases, the updated horizontal disparity is increased for an object that is repositioned to be closer to the camera. In some aspects, the updated horizontal disparity can be calculated based on or corresponding to the scaling of the subject configured by the user to make the edited subject appear larger or smaller. In some examples, the updated horizontal disparity can be based on depth information of the stereo image scene, such as the depth map 620 of FIG. 6, etc. In some cases, the updated horizontal disparity can be estimated based on the repositioned position of the subject in the edited left and right frames corresponding to the user configured manipulation. For example, as objects are scaled down, the disparity can be decreased according to an estimated scale, where the disparity approaches zero at a threshold distance from the cameras.

The object manipulation processing of FIG. 9 and/or FIG. 10, to remove, reposition, resize, etc., one or more selected objects, subjects, etc., within a scene corresponding to a stereo image pair can be performed during capture of the stereo image pair by the primary camera 612 and auxiliary camera 614 (e.g., before output of the encoded spatial video data from encoder 685 to the HMD 690, and/or before output of the final left-right output stereo pair of frames 692, 694 for display to a user of the HMD 690, etc.). In another illustrative example, object manipulation to reposition and/or resize objects from the final 3D scene of a spatial video, spatial photo, stereo image pair, etc., can be performed after capture as post-processing operations performed using the image capture device 602 and associated stereo image processing pipeline 605. In another example, object manipulation to reposition and/or resize objects from the final 3D scene of a spatial video, spatial photo, stereo image pair, etc., can be performed after capture as post-processing operations performed using the HMD 690 and associated HMD image processing system 695 and/or object manipulation engine 697, etc.

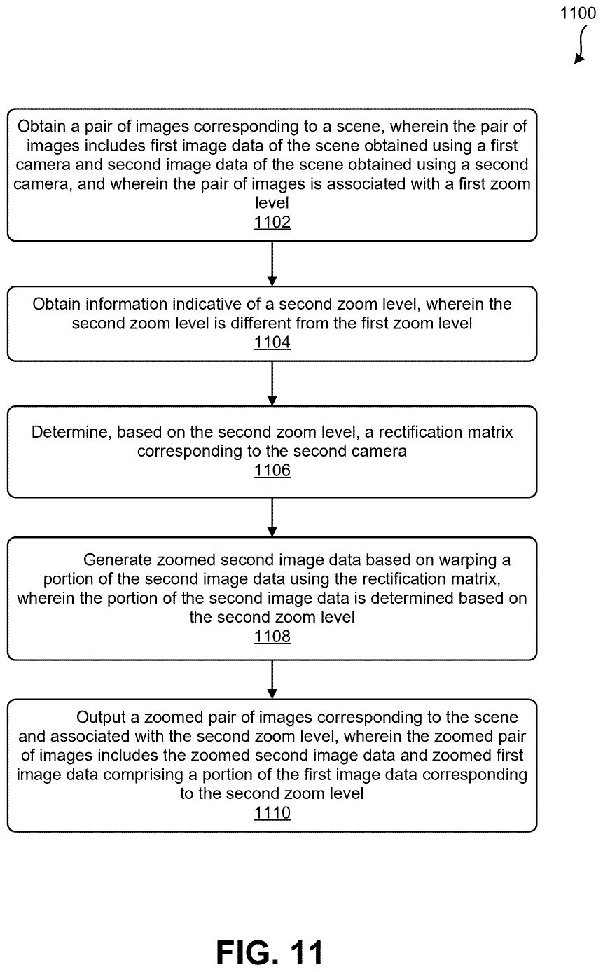

FIG. 11 is a flowchart diagram illustrating an example of a process 1100 for processing image and/or video data. In some examples, the process 1100 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. For example, the process 1100 can be performed by a mobile camera device, among various others, etc. The operations of the process 1100 may be implemented as software components that are executed and run on one or more processors (e.g., processor 1210 of FIG. 12 or other processor(s)).

At block 1102, the computing device (or component thereof) can obtain a pair of images corresponding to a scene, wherein the pair of images includes first image data of the scene obtained using a first camera and second image data of the scene obtained using a second camera, and wherein the pair of images is associated with a first zoom level. For example, the pair of images can be the same as or similar to the captured image frames 432 and 434 of FIG. 4; 532 and 534 of FIG. 5; 902 and 904 of FIG. 9; 1002 and 1004 of FIG. 10; etc. In some cases, the first and second camera can be the same as or similar to the cameras 332 and 334 of FIG. 3; 412 and 414 of FIG. 4; 512 and 514 of FIG. 5; 612 and 614 of FIG. 6; 702 of FIG. 7A; etc. In some cases, the pair of images is associated with a first set of zoom levels including zoom levels for the first image data and the second image data, where the second image data is cropped and/or rectified relative to the first image data based on the first set of zoom levels.

In some cases, the pair of images is a stereoscopic image pair. In some examples, the stereoscopic image pair comprises a left view of the scene and a right view of the scene. In some examples, the first camera and the second camera are included in a multi-camera image capture device and the pair of images comprises a stereoscopic image pair associated with a baseline distance between the first camera and the second camera. For example, the multi-camera image capture device can be any of the various devices of FIGS. 1A-10, etc. In some cases, a focal length associated with the first camera is longer than a focal length associated with the second camera.

In some examples, a field of view (FOV) associated with the second camera and the second image data is wider than an FOV associated with the first camera and the first image data. In some cases, the first camera comprises a wide-angle camera included in a multi-camera image capture device, and the second camera comprises an ultrawide angle camera included in the multi-camera image capture device. In some examples, the first camera is configured as a reference camera associated with a rectification matrix corresponding to the second camera.

At block 1104, the computing device (or component thereof) can obtain information indicative of a second zoom level, where the second zoom level is different from the first zoom level. In some cases, the information can be indicative of a second set of zoom levels for the first image data and the second image data, where the second set of zoom levels are different from the first set of zoom levels. In some cases, the zoom levels for the first image data and the second image data in the second set are the same or different. For example, the first zoom level and/or the first set of zoom levels can correspond to respective first focal lengths of the first camera and the second camera (e.g., a respective first focal length of the first camera, and a respective first focal length of the second camera), and the second zoom level and/or the second set of zoom levels can correspond to respective second focal lengths of the first camera and the second camera (e.g., a respective second focal length of the first camera, and a respective second focal length of the second camera).

In some cases, the computing device (or component thereof) can be configured to obtain calibration information associated with the first camera and the second camera, where the calibration information is indicative of the scale factor. The calibration information can be based on one or more of the respective second focal length of the first camera or the respective second focal length of the second camera.

At block 1106, the computing device (or component thereof) can determine a rectification matrix corresponding to the second camera, wherein the rectification matrix is based on the second zoom level. In some examples, the rectification matrix is based on the second set of zoom levels. In some cases, the computing device (or component thereof) can determine a scale factor corresponding to the second zoom level, and can determine the rectification matrix based at least in part on the scale factor and the second zoom level. In some cases, the computing device (or component thereof) can obtain calibration information associated with the first camera and the second camera, where the calibration information is indicative of the scale factor. The computing device (or component thereof) can determine the rectification matrix using the calibration information.

In some examples, obtaining the calibration information includes determining an adjusted focal length of the second camera corresponding to the second zoom level. In some cases, obtaining the calibration information can further include identifying an adjusted intrinsic matrix for the second camera based on the adjusted focal length, wherein the adjusted intrinsic matrix is indicative of the scale factor. In some cases, the rectification matrix is determined based on a rotation matrix corresponding to the second camera and the first camera, where the rotation matrix is included in the calibration information, and the adjusted intrinsic matrix for the second camera.

In some examples, the computing device (or component thereof) can obtain the calibration information by determining the calibration information based on performing a real-time calibration process to determine rotation information corresponding to relative rotation between an optical axis associated with the first camera and an optical axis associated with the second camera. For example, the rotation information can comprise a 3×3 rotation matrix indicative of a roll angle, a pitch angle, and a yaw angle corresponding to one or more of the first camera or the second camera. In some cases, the real-time calibration process includes determining camera intrinsic information corresponding to one or more of the first camera or the second camera, where the rectification matrix is determined using the camera intrinsic information and the rotation information.

At block 1108, the computing device (or component thereof) can generate zoomed second image data based on warping a portion of the second image data using the rectification matrix, wherein the portion of the second image data is determined based on the second set of zoom levels. In some examples, the portion of the second image data comprises a cropped frame of second image data obtained based on cropping the second image data according to the second set of zoom levels (e.g., the updated zoom level for the second image data). In some cases, the zoomed first image data comprises a cropped frame of the first image data based on cropping the first image data according to the second set of zoom levels (e.g., the updated zoom level for the first image data). In some examples, generating the zoomed second image data comprises using the rectification matrix to warp the cropped frame of second image data to minimize a vertical disparity with the cropped frame of the first image data.

At block 1110, the computing device (or component thereof) can output a zoomed pair of images corresponding to the scene and associated with the second set of zoom levels, wherein the zoomed pair of images includes the zoomed second image data and zoomed first image data comprising a portion of the first image data corresponding to the second set of zoom levels. For example, the zoomed pair of images can be the same as or similar to the images 592 and 594 of FIG. 5; 692 and 694 of FIG. 6; 932 and 934 of FIG. 9; 1032 and 1034 of FIG. 10; etc.

In some examples, the zoomed pair of images is a stereoscopic image pair including a left view of the scene at the second set of zoom levels and a right view of the scene at the second set of zoom levels. In some cases, respective horizontal disparity information corresponding to the zoomed pair of images is the same as respective horizontal disparity information corresponding to the pair of images. In some examples, the zoomed second image data is vertically aligned with the zoomed first image data based on the warping using the rectification matrix. In some examples, warping the portion of the second image data using the rectification matrix corresponds to minimizing vertical disparity between the zoomed first image data and the zoomed second image data.

In some examples, the processes described herein (e.g., process 1100 and/or any other process described herein, e.g., processes described with reference to FIG. 6 to FIG. 10) may be performed by a computing device, apparatus, or system. In one example, the process 1100 can be performed by a computing device or system having the computing device architecture 1200 of FIG. 12. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein, including the process 1100 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1100 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 illustrates an example computing device architecture 1200 of an example computing device which can implement the various techniques described herein. In some examples, the computing device can include a mobile device, a wearable device, an extended reality (XR) device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 1200 can implement the image processing pipeline 605 and/or the HMD image processing system 695 of FIG. 6, and/or various components thereof, etc. The components of computing device architecture 1200 are shown in electrical communication with each other using connection 1205, such as a bus. The example computing device architecture 1200 includes a processing unit (CPU or processor) 1210 and computing device connection 1205 that couples various computing device components including computing device memory 1215, such as read only memory (ROM) 1220 and random-access memory (RAM) 1225, to processor 1210.

Computing device architecture 1200 can include a cache of high-speed memory connected directly with, in close proximity to, or integrated as part of processor 1210. Computing device architecture 1200 can copy data from memory 1215 and/or the storage device 1230 to cache 1212 for quick access by processor 1210. In this way, the cache can provide a performance boost that avoids processor 1210 delays while waiting for data. These and other engines can control or be configured to control processor 1210 to perform various actions. Other computing device memory 1215 may be available for use as well. Memory 1215 can include multiple different types of memory with different performance characteristics. Processor 1210 can include any general-purpose processor and a hardware or software service, such as service 1 1232, service 2 1234, and service 3 1236 stored in storage device 1230, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

To enable user interaction with the computing device architecture 1200, input device 1245 can represent any number of input mechanisms, such as a microphone for speech, a touch-sensitive screen for gesture or graphical input, keyboard, mouse, motion input, speech and so forth. Output device 1235 can also be one or more of a number of output mechanisms known to those of skill in the art, such as a display, projector, television, speaker device, etc. In some examples, multimodal computing devices can enable a user to provide multiple types of input to communicate with computing device architecture 1200. Communication interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. Storage device 1230 can include services 1232, 1234, 1236 for controlling processor 1210. Other hardware or software modules or engines are contemplated. Storage device 1230 can be connected to the computing device connection 1205. In one aspect, a hardware module that performs a particular function can include the software component stored in a computer-readable medium in connection with the necessary hardware components, such as processor 1210, connection 1205, output device 1235, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects or examples. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that aspects and examples may be practiced without these specific details. For clarity of explanation, in some examples the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other examples, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects and examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects and examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The various illustrative logical blocks, modules, engines, circuits, and algorithm steps described in connection with the aspects and examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method comprising: obtaining a pair of images corresponding to a scene, wherein the pair of images includes first image data of the scene obtained using a first camera and second image data of the scene obtained using a second camera, and wherein the pair of images is associated with a first zoom level; obtaining information indicative of a second zoom level wherein the second zoom level is different from the first zoom level; determining, based on the second zoom level, a rectification matrix corresponding to the second camera; generating zoomed second image data based on warping a portion of the second image data using the rectification matrix, wherein the portion of the second image data is determined based on the second zoom level; and outputting a zoomed pair of images corresponding to the scene and associated with the second zoom level, wherein the zoomed pair of images includes the zoomed second image data and zoomed first image data comprising a portion of the first image data corresponding to the second zoom level.

Aspect 2. The method of Aspect 1, wherein determining the rectification matrix corresponding to the second camera comprises: determining a scale factor corresponding to the second zoom level; and determining the rectification matrix based at least in part on the scale factor and the second zoom level.

Aspect 3. The method of any of Aspects 1 to 2, wherein: the portion of the second image data comprises a cropped frame of second image data obtained based on cropping the second image data according to the second zoom level; and the portion of the first image data comprises a cropped frame of the first image data based on cropping the first image data according to the second zoom level.

Aspect 4. The method of Aspect 3, wherein generating the zoomed second image data comprises using the rectification matrix to warp the cropped frame of second image data to minimize a vertical disparity with the cropped frame of the first image data.

Aspect 5. The method of any of Aspects 1 to 4, wherein obtaining information indicative of the second zoom level includes obtaining one or more user inputs indicative of a configured zoom level corresponding to a spatial video.

Aspect 6. The method of Aspect 5, wherein the second zoom level and the configured zoom level corresponding to the spatial video are the same.

Aspect 7. The method of any of Aspects 5 to 6, wherein the zoomed pair of images comprises a respective frame of a plurality of frames of the spatial video.

Aspect 8. The method of any of Aspects 1 to 7, wherein the pair of images is a stereoscopic image pair.

Aspect 9. The method of Aspect 8, wherein the stereoscopic image pair comprises a left view of the scene and a right view of the scene.

Aspect 10. The method of any of Aspects 8 to 9, wherein the zoomed pair of images is a stereoscopic image pair including a left view of the scene at the second zoom level and a right view of the scene at the second zoom level.

Aspect 11. The method of Aspect 10, wherein respective horizontal disparity information corresponding to the zoomed pair of images is the same as respective horizontal disparity information corresponding to the pair of images.

Aspect 12. The method of any of Aspects 1 to 11, wherein the first zoom level corresponds to respective first focal lengths of the first camera and the second camera, and wherein the second zoom level corresponds to respective second focal lengths of the first camera and the second camera.

Aspect 13. The method of Aspect 12, wherein the respective first focal length of the first camera is different from the respective first focal length of the second camera, and wherein the respective second focal length of the first camera is different from the respective second focal length of the second camera.

Aspect 14. The method of any of Aspects 12 to 13, further comprising: obtaining calibration information associated with the first camera and the second camera, wherein the calibration information is indicative of a scale factor for determining the rectification matrix, and wherein the calibration information is based on one or more of the respective second focal length of the first camera or the respective second focal length of the second camera.

Aspect 15. The method of any of Aspects 1 to 14, further comprising: obtaining calibration information associated with the first camera and the second camera, wherein the calibration information is indicative of the scale factor for determining the rectification matrix; and determining the rectification matrix using the calibration information.

Aspect 16. The method of Aspect 15, wherein obtaining the calibration information includes: determining an adjusted focal length of the second camera corresponding to the second set of zoom levels; and identifying an adjusted intrinsic matrix for the second camera based on the adjusted focal length and the scale factor.

Aspect 17. The method of Aspect 16, wherein the rectification matrix is determined based on: a rotation matrix corresponding to the second camera and the first camera, wherein the rotation matrix is included in the calibration information; and the adjusted intrinsic matrix for the second camera.

Aspect 18. The method of any of Aspects 15 to 17, wherein obtaining the calibration information comprises: determining the calibration information based on performing a real-time calibration process to determine rotation information corresponding to relative rotation between an optical axis associated with the first camera and an optical axis associated with the second camera.

Aspect 19. The method of Aspect 18, wherein the real-time calibration process includes determining camera intrinsic information corresponding to one or more of the first camera or the second camera, and wherein the rectification matrix is determined using the camera intrinsic information and the rotation information.

Aspect 20. The method of any of Aspects 1 to 19, wherein the first camera and the second camera are included in a multi-camera image capture device, and wherein the pair of images comprises a stereoscopic image pair associated with a baseline distance between the first camera and the second camera.

Aspect 21. The method of Aspect 20, wherein a focal length associated with the first camera is longer than a focal length associated with the second camera.

Aspect 22. The method of any of Aspects 20 to 21, wherein a field of view (FOV) associated with the second camera and the second image data is wider than an FOV associated with the first camera and the first image data.

Aspect 23. The method of any of Aspects 1 to 22, wherein the first camera comprises a wide-angle camera included in a multi-camera image capture device, and wherein the second camera comprises an ultrawide angle camera included in the multi-camera image capture device.

Aspect 24. The method of any of Aspects 1 to 23, wherein the first camera is configured as a reference camera associated with the rectification matrix corresponding to the second camera.

Aspect 25. The method of any of Aspects 1 to 24, wherein the zoomed second image data is vertically aligned with the zoomed first image data based on the warping using the rectification matrix.

Aspect 26. The method of any of Aspects 1 to 25, wherein warping the portion of the second image data using the rectification matrix corresponds to minimizing vertical disparity between the zoomed first image data and the zoomed second image data.

Aspect 27. The method of any of Aspects 1 to 26, wherein the rectification matrix is for reducing a vertical disparity between the first image data and the second image data.

Aspect 28. The method of any of Aspects 1 to 27, wherein the rectification matrix is applied to transform the portion of the second image data to appear as if the zoomed pair of images were captured by aligned cameras with displacement therebetween in one direction.

Aspect 29. The method of Aspect 18, wherein the rotation information comprises a 3×3 rotation matrix indicative of a roll angle, a pitch angle, and a yaw angle corresponding to one or more of the first camera or the second camera.

Aspect 30. An apparatus for processing image data, comprising: at least one memory; and at least one processor coupled to the at least one memory, the at least one processor configured to: obtain a pair of images corresponding to a scene, wherein the pair of images includes first image data of the scene obtained using a first camera and second image data of the scene obtained using a second camera, and wherein the pair of images is associated with a first zoom level; obtain information indicative of a second zoom level, wherein the second zoom level is different from the first zoom level; determine, based on the second zoom level, a rectification matrix corresponding to the second camera; generate zoomed second image data based on warping a portion of the second image data using the rectification matrix, wherein the portion of the second image data is determined based on the second zoom level; and output a zoomed pair of images corresponding to the scene and associated with the second zoom level, wherein the zoomed pair of images includes the zoomed second image data and zoomed first image data comprising a portion of the first image data corresponding to the second zoom level.

Aspect 31. The apparatus of Aspect 30, wherein, to determine the rectification matrix corresponding to the second camera, the at least one processor is configured to: determine a scale factor corresponding to the second zoom level; and determine the rectification matrix based at least in part on the scale factor and the second zoom level.

Aspect 32. The apparatus of any of Aspects 30 to 31, wherein: the portion of the second image data comprises a cropped frame of second image data obtained based on cropping the second image data according to the second zoom level; and the portion of the first image data comprises a cropped frame of the first image data based on cropping the first image data according to the second zoom level.

Aspect 33. The apparatus of Aspect 32, wherein, to generate the zoomed second image data, the at least one processor is configured to use the rectification matrix to warp the cropped frame of second image data to minimize a vertical disparity with the cropped frame of the first image data.

Aspect 34. The apparatus of any of Aspects 30 to 33, wherein, to obtain information indicative of the second zoom level, the at least one processor is configured to obtain one or more user inputs indicative of a configured zoom level corresponding to a spatial video.

Aspect 35. The apparatus of Aspect 34, wherein the second zoom level and the configured zoom level corresponding to the spatial video are the same.

Aspect 36. The apparatus of any of Aspects 34 to 35, wherein the zoomed pair of images comprises a respective frame of a plurality of frames of the spatial video.

Aspect 37. The apparatus of any of Aspects 30 to 36, wherein the pair of images is a stereoscopic image pair.

Aspect 38. The apparatus of Aspect 37, wherein the stereoscopic image pair comprises a left view of the scene and a right view of the scene.

Aspect 39. The apparatus of any of Aspects 37 to 38, wherein the zoomed pair of images is a stereoscopic image pair including a left view of the scene at the second zoom level and a right view of the scene at the second zoom level.

Aspect 40. The apparatus of Aspect 39, wherein respective horizontal disparity information corresponding to the zoomed pair of images is the same as respective horizontal disparity information corresponding to the pair of images.

Aspect 41. The apparatus of any of Aspects 30 to 40, wherein the first zoom level corresponds to respective first focal lengths of the first camera and the second camera, and wherein the second zoom level corresponds to respective second focal lengths of the first camera and the second camera.

Aspect 42. The apparatus of Aspect 41, wherein the respective first focal length of the first camera is different from the respective first focal length of the second camera, and wherein the respective second focal length of the first camera is different from the respective second focal length of the second camera.

Aspect 43. The apparatus of any of Aspects 41 to 42, where the at least one processor is configured to: obtain calibration information associated with the first camera and the second camera, wherein the calibration information is indicative of a scale factor for determining the rectification matrix, and wherein the calibration information is based on one or more of the respective second focal length of the first camera or the respective second focal length of the second camera.

Aspect 44. The apparatus of any of Aspects 30 to 43, wherein the at least one processor is configured to: obtain calibration information associated with the first camera and the second camera, wherein the calibration information is indicative of the scale factor for determining the rectification matrix; and determine the rectification matrix using the calibration information.

Aspect 45. The apparatus of Aspect 44, wherein, to obtain the calibration information, the at least one processor is configured to: determine an adjusted focal length of the second camera corresponding to the second set of zoom levels; and identify an adjusted intrinsic matrix for the second camera based on the adjusted focal length and the scale factor.

Aspect 46. The apparatus of Aspect 45, wherein the rectification matrix is determined based on: a rotation matrix corresponding to the second camera and the first camera, wherein the rotation matrix is included in the calibration information; and the adjusted intrinsic matrix for the second camera.

Aspect 47. The apparatus of any of Aspects 44 to 46, wherein, to obtain the calibration information, the at least one processor is configured to: determine the calibration information based on performing a real-time calibration process to determine rotation information corresponding to relative rotation between an optical axis associated with the first camera and an optical axis associated with the second camera.

Aspect 48. The apparatus of Aspect 47, wherein the real-time calibration process includes determining camera intrinsic information corresponding to one or more of the first camera or the second camera, and wherein the rectification matrix is determined using the camera intrinsic information and the rotation information.

Aspect 49. The apparatus of any of Aspects 30 to 48, wherein the first camera and the second camera are included in a multi-camera image capture device, and wherein the pair of images comprises a stereoscopic image pair associated with a baseline distance between the first camera and the second camera.

Aspect 50. The apparatus of Aspect 49, wherein a focal length associated with the first camera is longer than a focal length associated with the second camera.

Aspect 51. The apparatus of any of Aspects 49 to 50, wherein a field of view (FOV) associated with the second camera and the second image data is wider than an FOV associated with the first camera and the first image data.

Aspect 52. The apparatus of any of Aspects 47 to 51, wherein the rotation information comprises a 3×3 rotation matrix indicative of a roll angle, a pitch angle, and a yaw angle corresponding to one or more of the first camera or the second camera.

Aspect 53. The apparatus of any of Aspects 30 to 52, wherein the first camera comprises a wide-angle camera included in a multi-camera image capture device, and wherein the second camera comprises an ultrawide angle camera included in the multi-camera image capture device.

Aspect 54. The apparatus of any of Aspects 30 to 53, wherein the first camera is configured as a reference camera associated with the rectification matrix corresponding to the second camera.

Aspect 55. The apparatus of any of Aspects 30 to 54, wherein the zoomed second image data is vertically aligned with the zoomed first image data based on the warping using the rectification matrix.

Aspect 56. The apparatus of any of Aspects 30 to 55, wherein, to warp the portion of the second image data using the rectification matrix, the at least one processor is configured to minimize vertical disparity between the zoomed first image data and the zoomed second image data.

Aspect 57. The apparatus of any of Aspects 30 to 56, wherein the rectification matrix is for reducing a vertical disparity between the first image data and the second image data.

Aspect 58. The apparatus of any of Aspects 30 to 57, wherein the rectification matrix is applied to transform the portion of the second image data to appear as if the zoomed pair of images were captured by aligned cameras with displacement therebetween in one direction.

Aspect 59. A non-transitory computer-readable storage medium comprising instructions stored thereon which, when executed by at least one processor, causes the at least one processor to perform operations according to any of Aspects 1 to 29.

Aspect 60. An apparatus for processing image data, comprising one or more means for performing operations according to any of Aspects 1 to 29.

Aspect 61. A method comprising: obtaining a pair of images corresponding to a scene, wherein the pair of images includes first image data of the scene obtained using a first camera and second image data of the scene obtained using a second camera, and wherein the pair of images is associated with a first set of zoom levels including zoom levels for the first image data and the second image data, wherein the second image data is cropped and/or rectified relative to the first image data based on the first set of zoom levels; obtaining information indicative of a second set of zoom levels for the first image data and the second image data, wherein the second set of zoom levels are different from the first set of zoom levels; determining, based on the second set of zoom levels, a rectification matrix corresponding to the second camera; generating zoomed second image data based on warping a portion of the second image data using the rectification matrix, wherein the portion of the second image data is determined based on the second set of zoom levels; and outputting a zoomed pair of images corresponding to the scene and associated with the second set of zoom levels, wherein the zoomed pair of images includes the zoomed second image data and zoomed first image data comprising a portion of the first image data corresponding to the second set of zoom levels.

Aspect 62. The method of Aspect 61, wherein determining the rectification matrix corresponding to the second camera comprises: determining a scale factor corresponding to the second zoom level, and determining the rectification matrix based at least in part on the scale factor and the second set of zoom levels.

Aspect 63. The method of any of Aspects 61 to 62, wherein zoom levels for the first image data and the second image data in the second set are the same or different.

Aspect 64. The method of any of Aspects 61 to 63, wherein: the portion of the second image data comprises a cropped frame of second image data obtained based on cropping the second image data according to the second set of zoom levels; and the portion of the first image data comprises a cropped frame of the first image data based on cropping the first image data according to the second set of zoom levels.

Aspect 65. The method of Aspect 64, wherein generating the zoomed second image data comprises using the rectification matrix to warp the cropped frame of second image data to minimize a vertical disparity with the cropped frame of the first image data.

Aspect 66. The method of any of Aspects 61 to 65, wherein obtaining information indicative of the second set of zoom levels includes obtaining one or more user inputs indicative of a configured zoom level corresponding to a spatial video.

Aspect 67. The method of Aspect 66, wherein the second set of zoom levels and the configured zoom level corresponding to the spatial video are the same.

Aspect 68. The method of any of Aspects 66 to 67, wherein the zoomed pair of images comprises a respective frame of a plurality of frames of the spatial video.

Aspect 69. The method of any of Aspects 61 to 68, wherein the pair of images is a stereoscopic image pair.

Aspect 70. The method of Aspect 69, wherein the stereoscopic image pair comprises a left view of the scene and a right view of the scene.

Aspect 71. The method of any of Aspects 69 to 70, wherein the zoomed pair of images is a stereoscopic image pair including a left view of the scene at the second set of zoom levels and a right view of the scene at the second set of zoom levels.

Aspect 72. The method of Aspect 71, wherein respective horizontal disparity information corresponding to the zoomed pair of images is the same as respective horizontal disparity information corresponding to the pair of images.

Aspect 73. The method of any of Aspects 71 to 72, wherein the first set of zoom levels corresponds to respective first focal lengths of the first camera and the second camera, and wherein the second set of zoom levels corresponds to respective second focal lengths of the first camera and the second camera.

Aspect 74. The method of Aspect 73, further comprising: obtaining calibration information associated with the first camera and the second camera, wherein the calibration information is indicative of a scale factor for determining the rectification matrix, and wherein the calibration information is based on one or more of the respective second focal length of the first camera or the respective second focal length of the second camera.

Aspect 75. The method of any of Aspects 61 to 74, further comprising: obtaining calibration information associated with the first camera and the second camera, wherein the calibration information is indicative of the scale factor for determining the rectification matrix; and determining the rectification matrix using the calibration information.

Aspect 76. The method of Aspect 75, wherein obtaining the calibration information includes: determining an adjusted focal length of the second camera corresponding to the second set of zoom levels; and identifying an adjusted intrinsic matrix for the second camera based on the adjusted focal length and the scale factor.

Aspect 77. The method of Aspect 76, wherein the rectification matrix is determined based on: a rotation matrix corresponding to the second camera and the first camera, wherein the rotation matrix is included in the calibration information; and the adjusted intrinsic matrix for the second camera.

Aspect 78. The method of any of Aspects 75 to 77, wherein obtaining the calibration information comprises: determining the calibration information based on performing a real-time calibration process to determine rotation information corresponding to relative rotation between an optical axis associated with the first camera and an optical axis associated with the second camera.

Aspect 79. The method of Aspect 78, wherein the real-time calibration process includes determining camera intrinsic information corresponding to one or more of the first camera or the second camera, and wherein the rectification matrix is determined using the camera intrinsic information and the rotation information.

Aspect 80. The method of any of Aspects 61 to 79, wherein the first camera and the second camera are included in a multi-camera image capture device, and wherein the pair of images comprises a stereoscopic image pair associated with a baseline distance between the first camera and the second camera.

Aspect 81. The method of Aspect 80, wherein a focal length associated with the first camera is longer than a focal length associated with the second camera.

Aspect 82. The method of any of Aspects 80 to 81, wherein a field of view (FOV) associated with the second camera and the second image data is wider than an FOV associated with the first camera and the first image data.

Aspect 83. The method of any of Aspects 61 to 82, wherein the first camera comprises a wide-angle camera included in a multi-camera image capture device, and wherein the second camera comprises an ultrawide angle camera included in the multi-camera image capture device.

Aspect 84. The method of any of Aspects 61 to 83, wherein the first camera is configured as a reference camera associated with the rectification matrix corresponding to the second camera.

Aspect 85. The method of any of Aspects 61 to 84, wherein the zoomed second image data is vertically aligned with the zoomed first image data based on the warping using the rectification matrix.

Aspect 86. The method of any of Aspects 61 to 85, wherein warping the portion of the second image data using the rectification matrix corresponds to minimizing vertical disparity between the zoomed first image data and the zoomed second image data.

Aspect 87. An apparatus for processing image data, comprising: at least one memory; and at least one processor coupled to the at least one memory, the at least one processor configured to: obtain a pair of images corresponding to a scene, wherein the pair of images includes first image data of the scene obtained using a first camera and second image data of the scene obtained using a second camera, and wherein the pair of images is associated with a first set of zoom levels including zoom levels for the first image data and the second image data, wherein the second image data is cropped and/or rectified relative to the first image data based on the first set of zoom levels; obtain information indicative of a second set of zoom levels for the first image data and the second image data, wherein the second set of zoom levels are different from the first zoom level; determine, based on the second set of zoom levels, a rectification matrix corresponding to the second camera; generate zoomed second image data based on warping a portion of the second image data using the rectification matrix, wherein the portion of the second image data is determined based on the second set of zoom levels; and output a zoomed pair of images corresponding to the scene and associated with the second set of zoom levels, wherein the zoomed pair of images includes the zoomed second image data and zoomed first image data comprising a portion of the first image data corresponding to the second set of zoom levels.

Aspect 88. A non-transitory computer-readable storage medium comprising instructions stored thereon which, when executed by at least one processor, causes the at least one processor to perform operations according to any of Aspects 61 to 86.

Aspect 89. An apparatus for processing image data, comprising one or more means for performing operations according to any of Aspects 61 to 86.

Aspect 90. A method comprising: obtaining a pair of images corresponding to a scene, wherein the pair of images includes first image data of the scene obtained using a first camera and second image data of the scene obtained using a second camera, and wherein the pair of images is associated with a first zoom level; obtaining information indicative of a second zoom level, wherein the second zoom level is different from the first zoom level; determining a rectification matrix corresponding to the second camera, wherein the rectification matrix is based on a scale factor corresponding to the second zoom level; generating zoomed second image data based on warping a portion of the second image data using the rectification matrix, wherein the portion of the second image data is determined based on the second zoom level; and outputting a zoomed pair of images corresponding to the scene and associated with the second zoom level, wherein the zoomed pair of images includes the zoomed second image data and zoomed first image data comprising a portion of the first image data corresponding to the second zoom level.

Aspect 91. The method of Aspect 90, wherein the pair of images is a stereoscopic image pair.

Aspect 92. The method of Aspect 91, wherein the stereoscopic image pair comprises a left view of the scene and a right view of the scene.

Aspect 93. The method of any of Aspects 91 to 92, wherein the zoomed pair of images is a stereoscopic image pair including a left view of the scene at the second zoom level and a right view of the scene at the second zoom level.

Aspect 94. The method of Aspect 93, wherein respective horizontal disparity information corresponding to the zoomed pair of images is the same as respective horizontal disparity information corresponding to the pair of images.

Aspect 95. The method of any of Aspects 90 to 94, wherein: the portion of the second image data comprises a cropped frame of second image data obtained based on cropping the second image data according to the second zoom level; and the zoomed first image data comprises a cropped frame of the first image data based on cropping the first image data according to the second zoom level.

Aspect 96. The method of Aspect 95, wherein generating the zoomed second image data comprises using the rectification matrix to warp the cropped frame of second image data to minimize a vertical disparity with the cropped frame of the first image data.

Aspect 97. The method of any of Aspects 90 to 96, wherein the first zoom level corresponds to respective first focal lengths of the first camera and the second camera, and wherein the second zoom level corresponds to respective second focal lengths of the first camera and the second camera.

Aspect 98. The method of Aspect 97, further comprising: obtaining calibration information associated with the first camera and the second camera, wherein the calibration information is indicative of the scale factor, and wherein the calibration information is based on one or more of the respective second focal length of the first camera or the respective second focal length of the second camera.

Aspect 99. The method of any of Aspects 90 to 98, further comprising: obtaining calibration information associated with the first camera and the second camera, wherein the calibration information is indicative of the scale factor; and determining the rectification matrix using the calibration information.

Aspect 100. The method of Aspect 99, wherein obtaining the calibration information includes: determining an adjusted focal length of the second camera corresponding to the second zoom level; and identifying an adjusted intrinsic matrix for the second camera based on the adjusted focal length, wherein the adjusted intrinsic matrix is indicative of the scale factor.

Aspect 101. The method of Aspect 100, wherein the rectification matrix is determined based on: a rotation matrix corresponding to the second camera and the first camera, wherein the rotation matrix is included in the calibration information; and the adjusted intrinsic matrix for the second camera.

Aspect 102. The method of any of Aspects 99 to 101, wherein obtaining the calibration information comprises: determining the calibration information based on performing a real-time calibration process to determine rotation information corresponding to relative rotation between an optical axis associated with the first camera and an optical axis associated with the second camera.

Aspect 103. The method of Aspect 102, wherein the rotation information comprises a 3×3 rotation matrix indicative of a roll angle, a pitch angle, and a yaw angle corresponding to one or more of the first camera or the second camera.

Aspect 104. The method of any of Aspects 102 to 103, wherein the real-time calibration process includes determining camera intrinsic information corresponding to one or more of the first camera or the second camera, and wherein the rectification matrix is determined using the camera intrinsic information.

Aspect 105. The method of any of Aspects 90 to 104, wherein the first camera and the second camera are included in a multi-camera image capture device, and wherein the pair of images comprises a stereoscopic image pair associated with a baseline distance between the first camera and the second camera.

Aspect 106. The method of Aspect 105, wherein a focal length associated with the first camera is longer than a focal length associated with the second camera.

Aspect 107. The method of any of Aspects 105 to 106, wherein a field of view (FOV) associated with the second camera and the second image data is wider than an FOV associated with the first camera and the first image data.

Aspect 108. The method of any of Aspects 90 to 107, wherein the first camera comprises a wide-angle camera included in a multi-camera image capture device, and wherein the second camera comprises an ultrawide angle camera included in the multi-camera image capture device.

Aspect 109. The method of any of Aspects 90 to 108, wherein the first camera is configured as a reference camera associated with the rectification matrix corresponding to the second camera.

Aspect 110. The method of any of Aspects 90 to 109, wherein the zoomed second image data is vertically aligned with the zoomed first image data based on the warping using the rectification matrix.

Aspect 111. The method of any of Aspects 90 to 110, wherein warping the portion of the second image data using the rectification matrix corresponds to minimizing vertical disparity between the zoomed first image data and the zoomed second image data.

Aspect 112. A method comprising: obtaining a pair of images corresponding to a scene, wherein the pair of images includes first image data of the scene obtained using a first camera and second image data of the scene obtained using a second camera; obtaining information indicative of an updated yaw angle corresponding to the first camera and the second camera, wherein the updated yaw angle is different than an initial yaw angle associated with the first image data and the second image data; determining, based on the updated yaw angle, a rectification matrix corresponding to the second camera, wherein the rectification matrix corresponds to rotation of the second camera based on the updated yaw angle; and outputting an adjusted pair of images corresponding to the scene, the adjusted pair of images comprising edited image data corresponding to the first image data and the second image data warped using the rectification matrix, wherein a difference between a parallax of the adjusted pair of images and a parallax of the pair of images is based on the updated yaw angle.

Aspect 113. The method of Aspect 112, further comprising: determining, based on the updated yaw angle, an additional rectification matrix corresponding to the first camera, wherein the additional rectification matrix corresponds to rotation of the first camera based on the updated yaw angle; and generating the edited image data corresponding to the first image data based on warping the first image data according to the additional rectification matrix.

Aspect 114. The method of any of Aspects 112 to 113, wherein the edited image data corresponding to the first image data comprises the first image data warped using an additional rectification matrix determined for the first camera.

Aspect 115. The method of Aspect 114, wherein the additional rectification matrix coexists with the second rectification matrix based on a rotation of the first camera and the rotation of the second camera.

Aspect 116. The method of any of Aspects 112 to 115, further comprising determining a rotation matrix corresponding to one or more of the first camera or the second camera, wherein the rotation matrix is determined based on the updated yaw angle.

Aspect 117. The method of Aspect 116, wherein the rotation matrix is determined using an initial roll angle determined between the first image data and the second image data, and an initial pitch angle determined between the first image data and the second image data.

Aspect 118. The method of any of Aspects 116 to 117, wherein determining the rectification matrix comprises using the updated yaw angle to update an initial rectification matrix associated with the second camera and the second image data.

Aspect 119. The method of any of Aspects 117 to 118, wherein the additional rectification matrix is determined based on camera intrinsic information corresponding to the first camera, and an additional rotation matrix determined based on using an opposite sign for the updated yaw angle.

Aspect 120. The method of any of Aspects 112 to 119, wherein the information indicative of the updated yaw angle comprises an offset from the initial yaw angle.

Aspect 121. The method of Aspect 120, further comprising receiving one or more user inputs indicative of the offset from the initial yaw angle.

Aspect 122. The method of any of Aspects 120 to 121, wherein the one or more user inputs are received using a graphical user interface (GUI) of a multi-camera image capture device including the first camera and the second camera.

Aspect 123. The method of any of Aspects 112 to 122, wherein the initial yaw angle is equal to zero, based on an optical axis associated with the first camera and the first image data being parallel to an optical axis associated with the second camera and the second image data.

Aspect 124. The method of Aspect 123, wherein the updated yaw angle is equal to a non-zero value and corresponds to the optical axis associated with the first camera converging with the optical axis associated with the second camera.

Aspect 125. The method of Aspect 124, wherein the parallax of the adjusted pair of images is decreased from the parallax of the pair of images.

Aspect 126. The method of any of Aspects 124 to 125, wherein the updated yaw angle is equal to a non-zero value and corresponds to the optical axis associated with the first camera diverging from the optical axis associated with the second camera.

Aspect 127. The method of Aspect 126, wherein the parallax of the adjusted pair of images is increased from the parallax of the pair of images.

Aspect 128. A method comprising: obtaining a pair of images corresponding to a scene, wherein the pair of images includes first image data of the scene obtained using a first camera and second image data of the scene obtained using a second camera, and wherein the scene includes a plurality of objects; obtaining an indication of a selected object of the plurality of objects for removal from the pair of images corresponding to the scene; removing first pixels corresponding to the selected object from the first image data and second pixels corresponding to the selected object from the second image data, respectively; generating first replacement pixels for the first pixels corresponding to the selected object based on the first image data, and second replacement pixels for the second pixels corresponding to the selected object based on the second image data; generating an edited first image data based on the first image data and the first replacement pixels and an edited second image data based on the second image data and the second replacement pixels; and outputting an edited pair of images corresponding to the scene with the selected object removed, wherein the edited pair of images includes the edited first image data and the edited second image data.

Aspect 129. The method of Aspect 128, wherein a first segmentation engine is used to remove pixels corresponding to the selected object from the first image data, and the first segmentation engine or a second segmentation engine is used to remove pixels corresponding to the selected object from the second image data.

Aspect 130. The method of any of Aspects 128 to 129, wherein a first engine is used to generate the first replacement pixels for the pixels corresponding to the selected object, the first replacement pixels based on the first image data of the scene.

Aspect 131. The method of any of Aspects 128 to 130, wherein the first engine or a second engine is used to generate the second replacement pixels for the pixels corresponding to the selected object, the second replacement pixels based on the second image data of the scene.

Aspect 132. The method of Aspect 131, wherein the second engine comprises an inpainting engine configured to generate the second replacement pixels as a plurality of inpainted pixels based on the second image data of the scene.

Aspect 133. The method of any of Aspects 131 to 132, wherein the first engine comprises an inpainting engine configured to generate the first replacement pixels as a plurality of inpainted pixels based on the first image data of the scene.

Aspect 134. The method of any of Aspects 128 to 133, wherein generating first replacement pixels and the second replacement pixels comprises: generating the first replacement pixels based on contextual information of neighboring pixels and/or neighboring portions of the selected object in the first image data, or non-removed background portions in the first image data; and generating the second replacement pixels based on contextual information of neighboring pixels and/or neighboring portions of the selected object in the second image data, or non-removed background portions in the second image data.

Aspect 135. A method comprising: obtaining a pair of images corresponding to a scene, wherein the pair of images includes first image data of the scene obtained using a first camera and second image data of the scene obtained using a second camera, and wherein the scene includes a plurality of objects; obtaining an indication of selected object of the plurality of objects for repositioning within the pair of images corresponding to the scene, wherein repositioning of the selected object corresponds to an increase or decrease in an apparent depth of the selected object within the scene; generating an edited first image data with the selected object repositioned and an edited second image data with the selected object repositioned, wherein a size of the selected object in the edited first image data and a size of the selected object in the edited second image data are increased or decreased based on the increase or decrease in the apparent depth; and outputting an edited pair of images corresponding to the scene with the selected object repositioned, wherein the edited pair of images includes the edited first image data and the edited second image data.

Aspect 136. The method of Aspect 135, wherein a horizontal disparity between the selected object within the edited pair of images is different from a horizontal disparity between the selected object within the pair of images.

Aspect 137. The method of any of Aspects 135 to 136, wherein the edited second image data with the selected object repositioned corresponds to the edited first image data.

Aspect 138. The method of any of Aspects 13546 to 137, wherein the edited first image data is generated based on using one or more image processing engines to process the first image data, and the edited second image data is generated based on using the one or more image processing engines to process the second image data.

Aspect 139. The method of Aspect 49, wherein the one or more image processing engines include: one or more segmentation engines configured to generate segmentation information indicative of pixels corresponding to the selected object in one or more of the first image data or the second image data; and one or more inpainting engines configured to generate inpainted pixels for replacement of the pixels corresponding to the selected object in the respective one or more of the first image data or the second image data, wherein the inpainted pixels are generated based on the scene.

Aspect 140. The method of any of Aspects 135 to 139, wherein: the repositioning of the selected object corresponds to increasing the apparent depth of the selected object within the scene; and the horizontal disparity between the selected object within the edited pair of images is decreased relative to the horizontal disparity between the selected object within the pair of images.

Aspect 141. The method of any of Aspects 135 to 140, wherein: the repositioning of the selected object corresponds to decreasing the apparent depth of the selected object within the scene; and the horizontal disparity between the selected object within the edited pair of images is increased relative to the horizontal disparity between the selected object within the pair of images.

Aspect 142. A method comprising: obtaining a pair of images corresponding to a scene, wherein the pair of images includes first image data of the scene obtained using a first camera and second image data of the scene obtained using a second camera, and wherein the scene includes a plurality of objects; obtaining an indication of selected object of the plurality of objects for manipulation within the pair of images corresponding to the scene; manipulating the selected object in the first image data and manipulating the selected object in the second image data; performing first image processing on a first region associated with the selected object in the first image data based on first image data, and performing second image processing on a second region associated with the selected object in the second image data based on second image data, to obtain first edited image data and second edited image data; and outputting an edited pair of images corresponding to the scene with the selected object manipulated, wherein the edited pair of images includes the edited first image data and the edited second image data.

Aspect 143. The method of Aspect 142, wherein the manipulation comprises removing the selected object or repositioning the selected object.

Aspect 144. The method according to Aspect 143, wherein, in case of removing the selected object, manipulating the selected object in the first image data and manipulating the selected object in the second image data comprises: removing first pixels corresponding to the selected object from the first image data and second pixels corresponding to the selected object from the second image data, respectively.

Aspect 145. The method according to Aspect 144, wherein, the first image processing and the second image processing comprises: generating first replacement pixels for the first pixels in the first region associated with the selected object based on the first image data, and second replacement pixels for the second pixels in the second region associated with the selected object based on the second image data; and generating the edited first image data based on the first image data and the first replacement pixels and the edited second image data based on the second image data and the second replacement pixels.

Aspect 146. The method according to any of Aspects 144 to 145, wherein, a first segmentation engine is used to determine the first region and remove the first pixels corresponding to the selected object from the first image data, and the first segmentation engine or a second segmentation engine is used to determine the second region and remove the second pixels corresponding to the selected object from the second image data.

Aspect 147. The method according to any of Aspects 145 to 146, wherein a first engine is used to generate the first replacement pixels for the first pixels corresponding to the selected object, the first replacement pixels based on the first image data of the scene.

Aspect 148. The method according to Aspect 147, wherein the first engine or a second engine is used to generate the second replacement pixels for the pixels corresponding to the selected object, the second replacement pixels based on the second image data of the scene.

Aspect 149. The method according to Aspect 148, wherein the second engine comprises an inpainting engine configured to generate the second replacement pixels as a plurality of inpainted pixels based on the second image data of the scene.

Aspect 150. The method according to any of Aspects 148 to 149, wherein the first engine comprises an inpainting engine configured to generate the first replacement pixels as a plurality of inpainted pixels based on the first image data of the scene.

Aspect 151. The method according to any of Aspects 145 to 150, wherein generating first replacement pixels and the second replacement pixels comprises: generating the first replacement pixels based on contextual information of neighboring pixels and/or neighboring portions of the selected object in the first image data, or non-removed background portions in the first image data; and generating the second replacement pixels based on contextual information of neighboring pixels and/or neighboring portions of the selected object in the second image data, or non-removed background portions in the second image data.

Aspect 152. The method according to any of Aspects 143 to 151, wherein, in case of repositioning the selected object, manipulating the selected object in the first image data and manipulating the selected object in the second image data comprises: repositioning the selected object from a first position to a second position in the first image data and repositioning the selected object from a first corresponding position to a second corresponding position in the second image data, wherein repositioning of the selected object corresponds to an increase or decrease in an apparent depth of the selected object within the scene; and resizing the selected object at the second position, and resizing the selected object at the second corresponding position.

Aspect 153. The method according to Aspect 152, wherein, the first image processing and the second image processing comprises: removing first pixels corresponding to a first region associated with the selected object at the first position from the first image data and second pixels corresponding to a second region associated with the selected object at the first corresponding position from the second image data, respectively; generating first replacement pixels for the first pixels based on the first image data, and second replacement pixels for the second pixels based on the second image data; generating the edited first image data based on the first image data, pixels of the resized selected object at the second position and the first replacement pixels, and generating the edited second image data based on the second image data, pixels of the resized selected object at the second corresponding position and the second replacement pixels.

Aspect 154. The method according to Aspect 153, wherein generating first replacement pixels and the second replacement pixels comprises: generating the first replacement pixels based on contextual information of neighboring pixels and/or neighboring portions of the selected object in the first image data, or non-removed background portions in the first image data; and generating the second replacement pixels based on contextual information of neighboring pixels and/or neighboring portions of the selected object in the second image data, or non-removed background portions in the second image data.

Aspect 155. The method according to any of Aspects 152 to 154, wherein a horizontal disparity between the selected object within the edited pair of images is different from a horizontal disparity between the selected object within the pair of images.

Aspect 156. The method according to any of Aspects 153 to 155, wherein the edited second image data with the selected object repositioned corresponds to the edited first image data.

Aspect 157. The method according to any of Aspects 153 to 156, wherein the edited first image data is generated based on using one or more image processing engines to process the first image data, and the edited second image data is generated based on using the one or more image processing engines to process the second image data.

Aspect 158. The method according to Aspect 157, wherein the one or more image processing engines include: one or more segmentation engines configured to generate segmentation information indicative of pixels corresponding to the selected object in one or more of the first image data or the second image data; and one or more inpainting engines configured to generate inpainted pixels for replacement of the pixels corresponding to the selected object in the respective one or more of the first image data or the second image data, wherein the inpainted pixels are generated based on the scene.

Aspect 159. The method according to any of Aspects 152 to 158, wherein: the repositioning of the selected object corresponds to increasing the apparent depth of the selected object within the scene; and the horizontal disparity between the selected object within the edited pair of images is decreased relative to the horizontal disparity between the selected object within the pair of images.

Aspect 160. The method according to any of Aspects 152 to 159, wherein: the repositioning of the selected object corresponds to decreasing the apparent depth of the selected object within the scene; and the horizontal disparity between the selected object within the edited pair of images is increased relative to the horizontal disparity between the selected object within the pair of images.

Aspect 161. An apparatus for processing image data, comprising: at least one memory; and at least one processor coupled to the at least one memory, the at least one processor configured to: obtain a pair of images corresponding to a scene, wherein the pair of images includes first image data of the scene obtained using a first camera and second image data of the scene obtained using a second camera, and wherein the pair of images is associated with a first zoom level; obtain information indicative of a second zoom level, wherein the second zoom level is different from the first zoom level; determine a rectification matrix corresponding to the second camera, wherein the rectification matrix is based on a scale factor corresponding to the second zoom level; generate zoomed second image data based on warping a portion of the second image data using the rectification matrix, wherein the portion of the second image data is determined based on the second zoom level; and output a zoomed pair of images corresponding to the scene and associated with the second zoom level, wherein the zoomed pair of images includes the zoomed second image data and zoomed first image data comprising a portion of the first image data corresponding to the second zoom level.

Aspect 162. An apparatus for processing image data, comprising: at least one memory; and at least one processor coupled to the at least one memory, the at least one processor configured to: obtain a pair of images corresponding to a scene, wherein the pair of images includes first image data of the scene obtained using a first camera and second image data of the scene obtained using a second camera; obtain information indicative of an updated yaw angle corresponding to the first camera and the second camera, wherein the updated yaw angle is different than an initial yaw angle associated with the first image data and the second image data; determine a second rectification matrix corresponding to the second camera and using the updated yaw angle, wherein the second rectification matrix corresponds to rotation of the second camera based on the updated yaw angle; and output an adjusted pair of images corresponding to the scene, the adjusted pair of images comprising edited image data corresponding to the first image data and the second image data warped using the second rectification matrix, wherein a difference between a parallax of the adjusted pair of images and a parallax of the pair of images is based on the updated yaw angle.

Aspect 163. An apparatus for processing image data, comprising: at least one memory; and at least one processor coupled to the at least one memory, the at least one processor configured to: obtain a pair of images corresponding to a scene, wherein the pair of images includes first image data of the scene obtained using a first camera and second image data of the scene obtained using a second camera, and wherein the scene includes a plurality of objects; obtain an indication of a selected object of the plurality of objects for removal from the pair of images corresponding to the scene; use a first segmentation engine to remove pixels corresponding to the selected object from the first image data and using a first engine to generate first replacement pixels for the pixels corresponding to the selected object, the first replacement pixels based on the first image data of the scene; generate an edited first image data based on the first image data and the first replacement pixels, wherein the edited first image data does not include the selected object; and output an edited pair of images corresponding to the scene with the selected object removed, wherein the edited pair of images includes the edited first image data and image data based on the second image data.

Aspect 164. An apparatus for processing image data, comprising: at least one memory; and at least one processor coupled to the at least one memory, the at least one processor configured to: obtain a pair of images corresponding to a scene, wherein the pair of images includes first image data of the scene obtained using a first camera and second image data of the scene obtained using a second camera, and wherein the scene includes a plurality of objects; obtain an indication of selected object of the plurality of objects for repositioning within the pair of images corresponding to the scene, wherein repositioning of the selected object corresponds to an increase or decrease in an apparent depth of the selected object within the scene; use one or more image processing engines to generate an edited first image data with the selected object repositioned, wherein a size of the selected object in the edited first image is increased or decreased based on the increase or decrease in the apparent depth; and output an edited pair of images corresponding to the scene with the selected object repositioned, wherein the edited pair of images includes the edited first image data and image data based on the second image data, and wherein a horizontal disparity between the selected object within the edited pair of images is different from a horizontal disparity between the selected object within the pair of images.

Aspect 165. An apparatus for processing image data, the apparatus comprising: at least one memory; and at least one processor coupled to the at least one memory, wherein the at least one processor is configured to perform operations according to any of Aspects 90 to 111.

Aspect 166. An apparatus for processing image data, the apparatus comprising: at least one memory; and at least one processor coupled to the at least one memory, wherein the at least one processor is configured to perform operations according to any of Aspects 112 to 127.

Aspect 167. An apparatus for processing image data, the apparatus comprising: at least one memory; and at least one processor coupled to the at least one memory, wherein the at least one processor is configured to perform operations according to any of Aspects 128 to 133.

Aspect 168. An apparatus for processing image data, the apparatus comprising: at least one memory; and at least one processor coupled to the at least one memory, wherein the at least one processor is configured to perform operations according to any of Aspects 134 to 141.

Aspect 169. A non-transitory computer-readable storage medium comprising instructions stored thereon which, when executed by at least one processor, causes the at least one processor to perform operations according to any of Aspects 90 to 111 or 161.

Aspect 170. A non-transitory computer-readable storage medium comprising instructions stored thereon which, when executed by at least one processor, causes the at least one processor to perform operations according to any of Aspects 112 to 127 or 162.

Aspect 171. A non-transitory computer-readable storage medium comprising instructions stored thereon which, when executed by at least one processor, causes the at least one processor to perform operations according to any of Aspects 128 to 133 or 163.

Aspect 172. A non-transitory computer-readable storage medium comprising instructions stored thereon which, when executed by at least one processor, causes the at least one processor to perform operations according to any of Aspects 134 to 141 or 164.

Aspect 173. An apparatus for processing image data, comprising one or more means for performing operations according to any of Aspects 90 to 111 or 161.

Aspect 174. An apparatus for processing image data, comprising one or more means for performing operations according to any of Aspects 112 to 127 or 162.

Aspect 175. An apparatus for processing image data, comprising one or more means for performing operations according to any of Aspects 128 to 133 or 163.

Aspect 176. An apparatus for processing image data, comprising one or more means for performing operations according to any of Aspects 134 to 141 or 164.

What is claimed is:

1. A method comprising:
obtaining a pair of images corresponding to a scene, wherein the pair of images includes first image data of the scene obtained using a first camera and second image data of the scene obtained using a second camera, and wherein the pair of images is associated with a first zoom level;
obtaining information indicative of a second zoom level wherein the second zoom level is different from the first zoom level;
determining, based on the second zoom level, a rectification matrix corresponding to the second camera;
generating zoomed second image data based on warping a portion of the second image data using the rectification matrix, wherein the portion of the second image data is determined based on the second zoom level; and
outputting a zoomed pair of images corresponding to the scene and associated with the second zoom level, wherein the zoomed pair of images includes the zoomed second image data and zoomed first image data comprising a portion of the first image data corresponding to the second zoom level.

2. The method of claim 1, wherein determining the rectification matrix corresponding to the second camera comprises:
determining a scale factor corresponding to the second zoom level; and
determining the rectification matrix based at least in part on the scale factor and the second zoom level.

3. The method of claim 1, wherein:
the portion of the second image data comprises a cropped frame of second image data obtained based on cropping the second image data according to the second zoom level; and
the portion of the first image data comprises a cropped frame of the first image data based on cropping the first image data according to the second zoom level.

4. The method of claim 3, wherein generating the zoomed second image data comprises using the rectification matrix to warp the cropped frame of second image data to minimize a vertical disparity with the cropped frame of the first image data.

5. The method of claim 1, wherein obtaining information indicative of the second zoom level includes obtaining one or more user inputs indicative of a configured zoom level corresponding to a spatial video.

6. The method of claim 5, wherein the second zoom level and the configured zoom level corresponding to the spatial video are the same.

7. The method of claim 5, wherein the zoomed pair of images comprises a respective frame of a plurality of frames of the spatial video.

8. The method of claim 1, wherein the pair of images is a stereoscopic image pair.

9. The method of claim 8, wherein the stereoscopic image pair comprises a left view of the scene and a right view of the scene.

10. The method of claim 8, wherein the zoomed pair of images is a stereoscopic image pair including a left view of the scene at the second zoom level and a right view of the scene at the second zoom level.

11. The method of claim 10, wherein respective horizontal disparity information corresponding to the zoomed pair of images is the same as respective horizontal disparity information corresponding to the pair of images.

12. The method of claim 1, wherein the first zoom level corresponds to respective first focal lengths of the first camera and the second camera, and wherein the second zoom level corresponds to respective second focal lengths of the first camera and the second camera.

13. The method of claim 12, wherein the respective first focal length of the first camera is different from the respective first focal length of the second camera, and wherein the respective second focal length of the first camera is different from the respective second focal length of the second camera.

14. The method of claim 12, further comprising:
obtaining calibration information associated with the first camera and the second camera, wherein the calibration information is indicative of a scale factor for determining the rectification matrix, and wherein the calibration information is based on one or more of the respective second focal length of the first camera or the respective second focal length of the second camera.

15. The method of claim 1, further comprising:
obtaining calibration information associated with the first camera and the second camera, wherein the calibration information is indicative of a scale factor for determining the rectification matrix; and
determining the rectification matrix using the calibration information.

16. The method of claim 15, wherein obtaining the calibration information includes:
determining an adjusted focal length of the second camera corresponding to the second zoom level; and
identifying an adjusted intrinsic matrix for the second camera based on the adjusted focal length and the scale factor.

17. The method of claim 16, wherein the rectification matrix is determined based on:
a rotation matrix corresponding to the second camera and the first camera, wherein the rotation matrix is included in the calibration information; and
the adjusted intrinsic matrix for the second camera.

18. The method of claim 15, wherein obtaining the calibration information comprises:
determining the calibration information based on performing a real-time calibration process to determine rotation information corresponding to relative rotation between an optical axis associated with the first camera and an optical axis associated with the second camera.

19. The method of claim 18, wherein the real-time calibration process includes determining camera intrinsic information corresponding to one or more of the first camera or the second camera, and wherein the rectification matrix is determined using the camera intrinsic information and the rotation information.

20. The method of claim 1, wherein the first camera and the second camera are included in a multi-camera image capture device, and wherein the pair of images comprises a stereoscopic image pair associated with a baseline distance between the first camera and the second camera.

21. The method of claim 20, wherein a focal length associated with the first camera is longer than a focal length associated with the second camera.

22. The method of claim 20, wherein a field of view (FOV) associated with the second camera and the second image data is wider than an FOV associated with the first camera and the first image data.

23. The method of claim 1, wherein the first camera comprises a wide-angle camera included in a multi-camera image capture device, and wherein the second camera comprises an ultrawide angle camera included in the multi-camera image capture device.

24. The method of claim 1, wherein the first camera is configured as a reference camera associated with the rectification matrix corresponding to the second camera.

25. The method of claim 1, wherein the zoomed second image data is vertically aligned with the zoomed first image data based on the warping using the rectification matrix.

26. The method of claim 1, wherein warping the portion of the second image data using the rectification matrix corresponds to minimizing vertical disparity between the zoomed first image data and the zoomed second image data.

27. The method of claim 1, wherein the rectification matrix is for reducing a vertical disparity between the first image data and the second image data.

28. The method of claim 1, wherein the rectification matrix is applied to transform the portion of the second image data to appear as if the zoomed pair of images were captured by aligned cameras with displacement therebetween in one direction.

29. An apparatus for processing image data, comprising:
at least one memory; and
at least one processor coupled to the at least one memory, the at least one processor configured to:
obtain a pair of images corresponding to a scene, wherein the pair of images includes first image data of the scene obtained using a first camera and second image data of the scene obtained using a second camera, and wherein the pair of images is associated with a first zoom level;
obtain information indicative of a second zoom level, wherein the second zoom level is different from the first zoom level;
determine, based on the second zoom level, a rectification matrix corresponding to the second camera;
generate zoomed second image data based on warping a portion of the second image data using the rectification matrix, wherein the portion of the second image data is determined based on the second zoom level; and
output a zoomed pair of images corresponding to the scene and associated with the second zoom level, wherein the zoomed pair of images includes the zoomed second image data and zoomed first image data comprising a portion of the first image data corresponding to the second zoom level.

30. The apparatus of claim 29, wherein, to determine the rectification matrix corresponding to the second camera, the at least one processor is configured to:
determine a scale factor corresponding to the second zoom level; and
determine the rectification matrix based at least in part on the scale factor and the second zoom level.
